(19) United States
(12) Patent Application Publication
(10) Pub. No.: US 2023/0035603 A1
(43) Pub. Date: Feb. 2, 2023

(54) ELECTRODEPOSITABLE COATING COMPOSITIONS

(71) Applicant: PPG Industries Ohio, Inc., Cleveland, OH (US)

(72) Inventors: David A. Stone, Allison Park, PA (US); Egle Puodziukynaite, Allison Park, PA (US); Joseph R. Swanger, Natrona Heights, PA (US); Venkatachalam Eswarakrishnan, Allison Park, PA (US); Craig A. Wilson, Allison Park, PA (US); Brian C. Okerberg, Gibsonia, PA (US); Hyun Wook Ro, Gibsonia, PA (US); Ross Anthony Moretti, Pittsburgh, PA (US)

(73) Assignee: PPG Industries Ohio, Inc., Cleveland, OH (US)

(21) Appl. No.: 17/758,076

(22) PCT Filed: Dec. 31, 2020
(86) PCT No.: PCT/US2020/067699

§ 371 Date: Jun. 28, 2022

Related U.S. Application Data
(60) Provisional application No. 62/955,600, filed on Dec. 31, 2019.

(51) Int. Cl. C09D 5/44; C09D 7/61; C09D 7/65

(52) U.S. Cl. CPC C09D 5/448; C09D 7/61; C09D 7/65

(57) ABSTRACT

The present invention is directed to an electrodepositable coating composition comprising an ionic salt group-containing film-forming polymer comprising active hydrogen functional groups; a blocked polyisocyanate curing agent comprising blocking groups, wherein at least 30% of the blocking groups comprise a 1,2-polyol as a blocking agent, based upon the total number of blocking groups; and a bismuth catalyst. Also disclosed are coatings, coated substrates, and methods of coating a substrate.

### FIELD OF THE INVENTION

The present invention is directed towards an electrodepositable coating composition, treated substrates and methods of coating substrates.

### BACKGROUND OF THE INVENTION

Electrodeposition as a coating application method involves the deposition of a film-forming composition onto a conductive substrate under the influence of an applied electrical potential. Electrodeposition has gained popularity in the coatings industry because it provides higher paint utilization, outstanding corrosion resistance, and low environmental contamination as compared with non-electrophoretic coating methods. Both cationic and anionic electrodeposition processes are used commercially. Blocked polyisocyanate curing agents are often used in electrodepositable coating compositions to effectuate cure of the coating once applied. Upon the application of external energy, such as heating, a blocking agent used to reversibly “block” the isocyanato groups of the blocked polyisocyanate curing agent is removed allowing the isocyanato groups to react with a polymeric binder resin and crosslink and cure the coating. Heating is often employed to remove blocking agents from a blocked isocyanato groups of the blocked polyisocyanate curing agent. Heating requires significant energy costs. Previous blocked polyisocyanate curing agents that unblock at relatively low temperatures have been difficult to make, are toxic, or are crystalline and difficult to handle. Additionally, while catalyst may be used to reduce the curing temperature of the coating composition, tin and lead catalysts have been subjected to a number of regulatory restrictions by various countries due to environmental concerns. Therefore, coating compositions that cure at low temperatures utilizing a non-tin and non-lead catalyst with a blocked polyisocyanate curing agent is desired.

### SUMMARY OF THE INVENTION

The present invention provides an electrodepositable coating composition comprising an ionic salt group-containing film-forming polymer comprising active hydrogen functional groups; a blocked polyisocyanate curing agent comprising blocking groups, wherein at least 30% of the blocking groups comprise a 1,2-polyol as a blocking agent, based upon the total number of blocking groups; and a bismuth catalyst.

The present invention also provides a method of coating a substrate comprising electrophoretically applying coating deposited from an electrodepositable coating composition of the present invention to at least a portion of the substrate.

The present invention further provides a coating deposited from an electrodepositable coating composition comprising an ionic salt group-containing film-forming polymer comprising active hydrogen functional groups; a blocked polyisocyanate curing agent comprising blocking groups, wherein at least 30% of the blocking groups comprise a 1,2-polyol as a blocking agent, based upon the total number of blocking groups; and a bismuth catalyst.

The present invention further provides a substrate coated with a coating deposited from the electrodepositable coating composition of the present invention.

### DETAILED DESCRIPTION OF THE INVENTION

The present invention is directed to an electrodepositable coating composition comprising an ionic salt group-containing film-forming polymer comprising active hydrogen functional groups; a blocked polyisocyanate curing agent comprising blocking groups, wherein at least 20% of the blocking groups comprise a 1,2-polyol as a blocking agent, based upon the total number of blocking groups; and a bismuth catalyst.

According to the present invention, the term “electrodepositable coating composition” refers to a composition that is capable of being deposited onto an electrically conductive substrate under the influence of an applied electrical potential. As further described herein, the electrodepositable coating composition may be a cationic electrodepositable coating composition or an anionic electrodepositable coating composition.

### Ionic Salt Group-Containing Film-Forming Polymer

According to the present invention, the electrodepositable coating composition comprises an ionic salt group-containing film-forming polymer. The ionic salt group-containing film-forming polymer is capable of being applied onto a substrate by electrodeposition. The ionic salt group-containing film-forming polymer may comprise a cationic salt group-containing film-forming polymer or an anionic salt group-containing film-forming polymer.

The ionic salt group-containing film-forming polymer may comprise a cationic salt group containing film-forming polymer. The cationic salt group-containing film-forming polymer may be used in a cationic electrodepositable coating composition. As used herein, the term “cationic salt group-containing film-forming polymer” refers to polymers that include at least partially neutralized cationic groups, such as sulfonium groups and ammonium groups, that impart a positive charge. The cationic salt group-containing film-forming polymer may comprise active hydrogen functional groups. The term “active hydrogen” refers to hydrogens which, because of their position in the molecule, display activity according to the Zerewitinoff test, as described in the JOURNAL OF THE AMERICAN CHEMICAL SOCIETY, Vol. 49, page 3181 (1927). Accordingly, active hydrogens include hydrogen atoms attached to oxygen, nitrogen, or sulfur, and thus active hydrogen functional groups include, for example, hydroxyl, thiol, primary amino, and/or secondary amino groups (in any combination). Cationic salt group-containing film-forming polymers that comprise active hydrogen functional groups may be referred to as active hydrogen-containing, cationic salt group-containing film-forming polymers.

Examples of polymers that are suitable for use as the cationic salt group-containing film-forming polymer in the present invention include, but are not limited to, alkyd polymers, acrylics, polyepoxides, polyamides, polyurethanes, polyureas, polyethers, and polyesters, among others.

More specific examples of suitable active hydrogen-containing, cationic salt group containing film-forming polymers include polyepoxide-amine adducts, such as the adduct of a polyglycidyl ethers of a polyphenol, such as Bisphenol A, and primary and/or secondary amines, such as are described in U.S. Pat. No. 4,031,050 at col. 3, line 27 to col. 5, line 50, U.S. Pat. No. 4,452,963 at col. 5, line 58 to col. 6, line 66, and U.S. Pat. No. 6,017,432 at col. 2, line 66 to col. 6, line 26, these portions of which being incorporated herein by reference. A portion of the amine that is reacted with the polyepoxide may be a ketimine of a polyamine, as is described in U.S. Pat. No. 4,104,147 at col. 6, line 23 to col. 7, line 23, the cited portion of which being incorporated herein by reference. Also suitable are ungelled polyepoxide-polyoxyalkylenepolyamine resins, such as are described in U.S. Pat. No. 4,432,850 at col. 2, line 60 to col. 5, line 58, the cited portion of which being incorporated herein by reference. In addition, cationic acrylic resins, such as those described in U.S. Pat. No. 3,455,806 at col. 2, line 18 to col. 3, line 61 and 3,928,157 at col. 2, line 29 to col. 3, line 21, these portions of both of which are incorporated herein by reference, may be used.

Besides amine salt group-containing resins, quaternary ammonium salt group-containing resins may also be employed as a cationic salt group-containing film-forming polymer in the present invention. Examples of these resins are those which are formed from reacting an organic polyepoxide with a tertiary amine acid salt. Such resins are described in U.S. Pat. No. 3,962,165 at col. 2, line 3 to col. 11, line 7; 3,975,346 at col. 1, line 62 to col. 17, line 25 and U.S. Pat. No. 4,001,156 at col. 1, line 37 to col. 16, line 7, these portions of which being incorporated herein by reference. Examples of other suitable cationic resins include ternary sulfonium salt group-containing resins, such as those described in U.S. Patent. No. 3,793,278 at col. 1, line 32 to col. 5, line 20, this portion of which being incorporated herein by reference. Also, cationic resins which cure via a transesterification mechanism, such as described in European Patent Application No. 12463B1 at pg. 2, line 1 to pg. 6, line 25, this portion of which being incorporated herein by reference, may be employed.

Other suitable cationic salt group-containing film-forming polymers include those that may form photodegradation resistant electrodepositable coating compositions. Such polymers include the polymers comprising cationic amine salt groups which are derived from pendant and/or terminal amino groups that are disclosed in U.S. Pat. Application Publication No. 2003/0054193 A1 at paragraphs [0064] to [0088], this portion of which being incorporated herein by reference. Also suitable are the active hydrogen-containing, cationic salt group-containing resins derived from a polyglycidyl ether of a polyhydric phenol that is essentially free of aliphatic carbon atoms to which are bonded more than one aromatic group, which are described in U.S. Pat. Application Publication No. 2003/0054193 A1 at paragraphs [0096] to [0123], this portion of which being incorporated herein by reference.

The active hydrogen-containing, cationic salt group-containing film-forming polymer is made cationic and water dispersible by at least partial neutralization with an acid. Suitable acids include organic and inorganic acids. Non-limiting examples of suitable organic acids include formic acid, acetic acid, methanesulfonic acid, and lactic acid. Non-limiting examples of suitable inorganic acids include phosphoric acid and sulfamic acid. By “sulfamic acid” is meant sulfamic acid itself or derivatives thereof such as those having the formula:

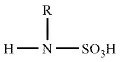

wherein R is hydrogen or an alkyl group having 1 to 4 carbon atoms. Mixtures of the above-mentioned acids also may be used in the present invention.

The extent of neutralization of the cationic salt group-containing film-forming polymer may vary with the particular polymer involved. However, sufficient acid should be used to sufficiently neutralize the cationic salt-group containing film-forming polymer such that the cationic salt-group containing film-forming polymer may be dispersed in an aqueous dispersing medium at room temperature in the amounts described herein. For example, the amount of acid used may provide at least 20% of all of the total theoretical neutralization. Excess acid may also be used beyond the amount required for 100% total theoretical neutralization. For example, the amount of acid used to neutralize the cationic salt group-containing film-forming polymer may be ≧0.1% based on the total amines in the active hydrogen-containing, cationic salt group-containing film-forming polymer. Alternatively, the amount of acid used to neutralize the active hydrogen-containing, cationic salt group-containing film-forming polymer may be ≦100% based on the total amines in the active hydrogen-containing, cationic salt group-containing film-forming polymer. The total amount of acid used to neutralize the cationic salt group-containing film-forming polymer may range between any combination of values, which were recited in the preceding sentences, inclusive of the recited values. For example, the total amount of acid used to neutralize the active hydrogen-containing, cationic salt group-containing film-forming polymer may be equal to or greater than 20%, 35%, 50%, 60%, or 80% based on the total amines in the cationic salt group-containing film-forming polymer.

The cationic salt group-containing film-forming polymer may be present in the cationic electrodepositable coating composition in an amount of at least 40% by weight, such as at least 50% by weight, such as at least 60% by weight, and may be present in the in an amount of no more than 90% by weight, such as no more than 80% by weight, such as no more than 75% by weight, based on the total weight of the resin solids of the electrodepositable coating composition. The cationic salt group-containing film-forming polymer may be present in the cationic electrodepositable coating composition in an amount of 40% to 90% by weight, such as 50% to 80% by weight, such as 60% to 75% by weight, based on the total weight of the resin solids of the electrodepositable coating composition.

Alternatively, the ionic salt group containing film-forming polymer may comprise an anionic salt group-containing film-forming polymer. As used herein, the term “anionic salt group-containing film-forming polymer” refers to an anionic polymer comprising at least partially neutralized anionic functional groups, such as carboxylic acid and phosphoric acid groups, that impart a negative charge to the polymer. The anionic salt group-containing film-forming polymer may comprise active hydrogen functional groups. Anionic salt group-containing film-forming polymers that comprise active hydrogen functional groups may be referred to as active hydrogen-containing, anionic salt group-containing film-forming polymers. The anionic salt group containing film-forming polymer may be used in an anionic electrodepositable coating composition.

The anionic salt group-containing film-forming polymer may comprise base-solubilized, carboxylic acid group-containing film-forming polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Still another suitable anionic electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. Other acid functional polymers may also be used such as phosphatized polyepoxide or phosphatized acrylic polymers. Exemplary phosphatized polyepoxides are disclosed in U.S. Pat. Application Publication No. 2009-0045071 at [0004]-[0015] and U.S. Pat. Application No. 13/232,093 at [0014]-[0040], the cited portions of which being incorporated herein by reference. Also suitable are resins comprising one or more pendent carbamate functional groups, such as those described in U.S. Pat. No. 6,165,338.

The anionic salt group-containing film-forming polymer may be present in the anionic electrodepositable coating composition in an amount of at least 50% by weight, such as at least 55% by weight, such as at least 60% by weight, and may be present in an amount of no more than 90% by weight, such as no more than 80% by weight, such as no more than 75% by weight, based on the total weight of the resin solids of the electrodepositable coating composition. The anionic salt group-containing film-forming polymer may be present in the anionic electrodepositable coating composition in an amount 50% to 90%, such as 55% to 80%, such as 60% to 75%, based on the total weight of the resin solids of the electrodepositable coating composition.

The ionic salt group-containing film-forming polymer may be present in the electrodepositable coating composition in an amount of at least 40% by weight, such as at least 50% by weight, such as at least 55% by weight, such as at least 60% by weight, based on the total weight of the resin solids of the electrodepositable coating composition. The ionic salt group-containing film-forming polymer may be present in the electrodepositable coating composition in an amount of no more than 90% by weight, such as no more than 80% by weight, such as no more than 75% by weight, based on the total weight of the resin solids of the electrodepositable coating composition. The ionic salt group-containing film-forming polymer may be present in the electrodepositable coating composition in an amount of 40% to 90% by weight, such as 50% to 90% by weight, such as 50% to 80% by weight, such as 55% to 80% by weight, such as 60% to 75% by weight, based on the total weight of the resin solids of the electrodepositable coating composition.

### Blocked Polyisocyanate Curing Agent

According to the present invention, the electrodepositable coating composition of the present invention further comprises a blocked polyisocyanate curing agent.

As used herein, a “blocked polyisocyanate” means a polyisocyanate wherein at least a portion of the isocyanato groups are blocked by a blocking group introduced by the reaction of a free isocyanato group of the polyisocyanate with a blocking agent. By “blocked” is meant that the isocyanato groups have been reacted with a blocking agent such that the resultant blocked isocyanate group is stable to active hydrogens at ambient temperature, e.g. room temperature (about 23° C.), but reactive with active hydrogens in the film-forming polymer at elevated temperatures, such as, for example, between 90° C. and 200° C. Therefore, a blocked polyisocyanate curing agent comprises a polyisocyanate reacted with one or more blocking agent(s). As used herein, a “blocking agent” refers to a compound comprising a functional group reactive with an isocyanato group present on the polyisocyanate resulting in binding a residual moiety of the blocking agent to the isocyanato group so that the isocyanato group is stable to active hydrogen functional groups at room temperature (i.e., 23° C.). The bound residual moiety of a blocking agent to the isocyanato group, which provides stability of the isocyanato group towards active hydrogen functional groups at room temperature, is referred to as a “blocking group” herein. Blocking groups may be identified by reference to the blocking agent from which they are derived by reaction with an isocyanato group. Blocking groups may be removed under suitable conditions, such as at elevated temperatures such that free isocyanato groups may be generated from the blocked isocyanato groups. Thus, the reaction with the blocking agent may be reversed at elevated temperature such that the previously blocked isocyanato group is free to react with active hydrogen functional groups. As used herein, the term “derived from” with respect to the blocking group of the blocked polyisocyanate is intended to refer to the presence of the residue of a blocking agent in the blocking group and is not intended to be limited to a blocking group produced by reaction of an isocyanato group of the polyisocyanate with the blocking agent. Accordingly, a blocking group of the present invention resulting from synthetic pathways that do not include direct reaction of the isocyanato group and blocking agent will still be considered to be “derived from” the blocking agent. Accordingly, the term “blocking agent” may also be used to refer to the moiety of the blocked polyisocyanate that leaves a blocking group during cure to produce a free isocyanato group. As used herein, the term “blocked” polyisocyanate curing agent" collectively refers to a fully blocked polyisocyanate curing agent and an at least partially blocked polyisocyanate curing agent. As used herein, a “fully blocked polyisocyanate curing agent” refers to a polyisocyanate wherein each of the isocyanato groups has been blocked with a blocking group. As used herein, an “at least partially blocked polyisocyanate curing agent” refers to a polyisocyanate wherein at least a portion of the isocyanato groups have been blocked with a blocking group while the remaining isocyanato groups have been reacted with a portion of the polymer backbone.

The blocked polyisocyanate curing agent comprises isocyanato groups that are reactive with the reactive groups, such as active hydrogen groups, of the ionic salt group-containing film-forming polymer to effectuate cure of the coating composition to form a coating. As used herein, the term “cure”, “cured” or similar terms, as used in connection with the electrodepositable coating compositions described herein, means that at least a portion of the components that form the electrodepositable coating composition are crosslinked to form a coating. Additionally, curing of the electrodepositable coating composition refers to subjecting said composition to curing conditions (e.g., elevated temperature) leading to the unblocking of the blocked isocyanato groups of the blocked polyisocyanate curing agent to result in reaction of the unblocked isocyanato groups of the polyisocyanate curing agent with active hydrogen functional groups of the film-forming polymer, and resulting in the crosslinking of the components of the electrodepositable coating composition and formation of an at least partially cured coating. Blocking agents removed during cure may be removed from the coating film by volatilization. Alternatively, a portion or all of the blocking agent may remain in the coating film following cure.

The polyisocyanates that may be used in preparing the blocked polyisocyanate curing agent of the present invention include any suitable polyisocyanate known in the art. A polyisocyanate is an organic compound comprising at least two, at least three, at least four, or more isocyanato functional groups, such as two, three, four, or more isocyanato functional groups. For example, the polyisocyanate may comprise aliphatic and/or aromatic polyisocyanates. As will be understood, an aromatic polyisocyanate will have a nitrogen atom of an isocyanate group covalently bound to a carbon present in an aromatic group, and an aliphatic polyiscoayante may contain an aromatic group that is indirectly bound to the isocyanato group through a non-aromatic hydrocarbon group. Aliphatic polyisocyanates may include, for example, (i) alkylene isocyanates, such as trimethylene diisocyanate, tetramethylene diisocyanate, pentamethylene diisocyanate, hexamethylene diisocyanate (“HDI”), 1,2-propylene diisocyanate, 1,2-butylene diisocyanate, 2,3-butylene diisocyanate, 1,3-butylene diisocyanate, ethylidene diisocyanate, and butylidene diisocyanate, and (ii) cycloalkylene isocyanates, such as 1,3-cyclopentane diisocyanate, 1,4-cyclohexane diisocyanate, 1,2-cyclohexane diisocyanate, isophorone diisocyanate, methylene bis(4-cyclohexylisocyanate) (“HMDI”), the cyclo-trimer of 1,6-hexamethylene diisocyanate (also known as the isocyanurate trimer of HDI, commercially available as Desmodur N3300 from Convestro AG), and meta-tetramethylxylylene diisocyanate (commercially available as TMXDI® from Allnex SA). Aromatic polyisocyanates may include, for example, (i) arylene isocyanates, such as m-phenylene diisocyanate, p-phenylene diisocyanate, 1,5-naphthalene diisocyanate and 1,4-naphthalene diisocyanate, and (ii) alkarylene isocyanates, such as 4,4'-diphenylene methane diisocyanate (“MDI”), 2,4-tolylene or 2,6-tolylene diisocyanate (“TDI”), or mixtures thereof, 4,4-toluidine diisocyanate and xylylene diisocyanate. Triisocyanates, such as triphenyl methane-4,4',4"-triisocyanate, 1,3,5-triisocyanato benzene and 2,4,6-triisocyanato toluene, tetraisocyanates, such as 4,4'-diphenyldimethyl methane-2,2',5,5'-tetraisocyanate, and polymerized polyisocyanates, such as tolylene diisocyanate dimers and trimers and the like, may also be used. The blocked polyisocyanate curing agent may also comprise a polymeric polyisocyanate, such as polymeric HDI, polymeric MDI, polymeric isophorone diisocyanate, and the like. The curing agent may also comprise a blocked trimer of hexamethylene diisocyanate available as Desmodur N3300® from Covestro AG. Mixtures of polyisocyanate curing agents may also be used.

As discussed above, the isocyanato groups of the polyisocyanate are blocked with a blocking agent such that the blocked polyisocyanate curing agent comprises blocking groups. The blocking groups may be formed by reacting the isocyanato groups with a molar ratio of blocking agents. For example, the isocyanato groups may be reacted with a 1:1 molar ratio of isocyanato groups to blocking agents such that the isocyanato groups are theoretically 100% blocked with the blocking agents. Alternatively, the molar ratio of isocyanato groups to blocking agents may be such that the isocyanato groups or blocking agent is in excess. The blocking group itself is a urethane group that contains the residues of the isocyanato group and blocking agent.

According to the present invention, the blocking agent may comprise a 1,2-polyol. The 1,2-polyol will react with an isocyanato group of the polyisocyanate to form a blocking group. The 1,2-polyol may comprise at least 30%, such as at least 35%, such as at least 40%, such as at least 45%, such as at least 50%, such as at least 55%, such as at least 60%, such as at least 65%, such as at least 70%, such as at least 75%, such as at least 80%, such as at least 85%, such as at least 90%, such as at least 95%, such as at least 99%, such as 100%, based upon the total number of blocking groups. The 1,2-polyol may comprise no more than 100% of the blocking groups of the blocked polyisocyanate curing agent, such as no more than 99%, such as no more than 95%, such as no more than 90%, such as no more than 85%, such as no more than 80%, such as no more than 75%, such as no more than 70%, such as no more than 65%, such as no more than 60%, such as no more than 55%, such as no more than 50%, such as no more than 45%, such as no more than 40%, such as no more than 35%, such as no more than 30%, based upon the total number of blocking groups. The 1,2-polyol may comprise 30% to 100% of the blocking groups of the blocked polyisocyanate curing agent, such as 30% to 100%, such as 35% to 100%, such as 40% to 100%, such as 45% to 100%, such as 50% to 100%, such as 55% to 100%, such as 60% to 100%, 65% to 100%, such as 70% to 100%, such as 75% to 100%, such as 80% to 100%, 85% to 100%, such as 90% to 100%, such as 95% to 100%, such as 30% to 95%, such as 35% to 95%, such as 40% to 95%, such as 45% to 95%, such as 50% to 95%, such as 55% to 95%, such as 60% to 95%, 65% to 95%, such as 70% to 95%, such as 75% to 95%, such as 80% to 95%, 85% to 95%, such as 90% to 95%, such as 30% to 90%, such as 35% to 90%, such as 40% to 90%, such as 45% to 90%, such as 50% to 90%, such as 55% to 90%, such as 60% to 90%, 65% to 90%, such as 70% to 90%, such as 75% to 90%, such as 80% to 90%, 85% to 90%, such as 30% to 85%, such as 35% to 85%, such as 40% to 85%, such as 45% to 85%, such as 50% to 85%, such as 55% to 85%, such as 60% to 85%, 65% to 85%, such as 70% to 85%, such as 75% to 85%, such as 80% to 85%, such as 30% to 80%, such as 35% to 80%, such as 40% to 80%, such as 45% to 80%, such as 50% to 80%, such as 55% to 80%, such as 60% to 80%, 65% to 80%, such as 70% to 80%, such as 75% to 80%, such as 30% to 75%, such as 35% to 75%, such as 40% to 75%, such as 45% to 75%, such as 50% to 75%, such as 55% to 75%, such as 60% to 75%, 65% to 75%, such as 70% to 75%, such as 30% to 70%, such as 35% to 70%, such as 40% to 70%, such as 45% to 70%, such as 50% to 70%, such as 55% to 70%, such as 60% to 70%, 65% to 70%, such as 30% to 65%, such as 35% to 65%, such as 40% to 65%, such as 45% to 65%, such as 50% to 65%, such as 55% to 65%, such as 60% to 65%, such as 30% to 60%, such as 35% to 60%, such as 40% to 60%, such as 45% to 60%, such as 50% to 60%, such as 55% to 60%, such as 30% to 55%, such as 35% to 55%, such as 40% to 55%, such as 45% to 55%, such as 50% to 55%, such as 30% to 50%, such as 35% to 50%, such as 40% to 50%, such as 45% to 50%, such as 30% to 45%, such as 35% to 45%, such as 40% to 45%, such as 30% to 40%, such as 35% to 40%, such as 30% to 35%, based upon the total number of blocking groups. As used herein, the percentage of blocking groups of the blocked polyisocyanate curing agent with respect to a blocking agent refers to the molar percentage of isocyanato groups blocked by that blocking agent divided by the total number of isocyanato groups actually blocked, i.e., the total number of blocking groups. The percentage of blocking groups may be determined by dividing the total moles of blocking groups blocked with a specific blocking agent by the total moles of blocking groups of the blocked polyisocyanate curing agent and multiplying by 100. It may also be expressed in equivalents of the blocking agent to total equivalents of isocyanato groups from the polyisocyanate, and the percentages and equivalents may be converted and used interchangeably (e.g., 40% of the total blocking groups is the same as 4/10 equivalents). For clarity, when reference is made to blocking groups, blocked with a blocking agent, the blocking group does not need to be derived strictly from reaction of the isocyanato group with the blocking agent and may be made by any synthetic pathway, as discussed below.

The 1,2-polyol may comprise a 1,2-alkane diol. Non-limiting examples of the 1,2-alkane diol include ethylene glycol, propylene glycol, 1,2-butane diol, 1,2-pentane diol, 1,2-hexane diol, 1,2-heptanediol, 1,2-octanediol, glycerol esters or ethers having a 1,2-dihydroxyl-functionality, and the like, and may include combinations thereof.

As discussed above, the isocyanato groups of the polyisocyanate are blocked with a blocking agent such that the blocked polyisocyanate curing agent comprises blocking groups to produce a urethane-containing compound. Accordingly, the blocked polyisocyanate curing agent may be referred to by the resulting structure that occurs after reaction of the isocyanato group and blocking agent, and the blocked polyisocyanate curing agent may comprise the structure:

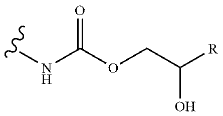

wherein R is hydrogen or a substituted or unsubstituted alkyl group comprising 1 to 8 carbon atoms, such as 1 to 6 carbon atoms, and wherein the substituted alkyl group optionally comprises an ether or ester functional group.

Although the blocked polyisocyanate curing agent is generally disclosed as being produced by reaction of the isocyanato group and blocking agent, it should be understood that any synthetic pathway that would produce the blocked polyisocyante curing agent of the structure above could be used to produce the blocked polyisocyanate curing agent of the present invention. For example, as shown in the reaction schematic below, an isocyanato group of a polyisocyanate (with the remainder of the polyisocyanate referred to as “X”) could be reacted with the hydroxyl-group of a hydroxyl- and epoxide-functional compound, with the result epoxide group then reacted with a hydroxyl-containing compound (wherein R is an alkyl group).

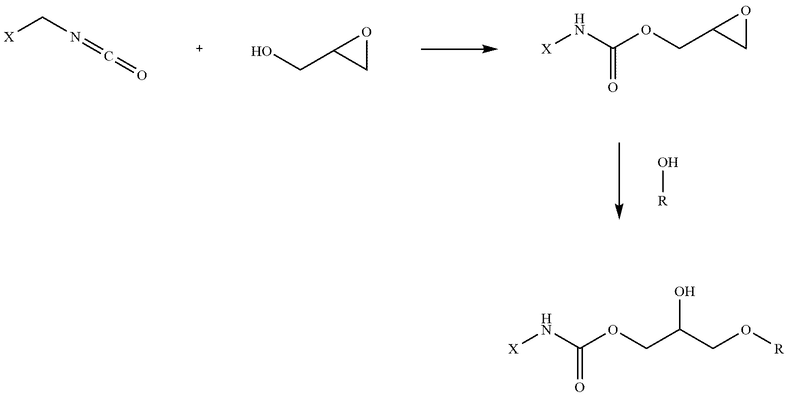

In addition to the 1,2-polyol, the blocked polyisocyanate may optionally further comprise a co-blocking agent. The co-blocking agent may comprise any suitable blocking agent. The co-blocking agent may comprise aliphatic, cycloaliphatic, or aromatic alkyl monoalcohols or phenolic compounds, including, for example, lower aliphatic alcohols, such as methanol, ethanol, and n-butanol; cycloaliphatic alcohols, such as cyclohexanol; aromatic-alkyl alcohols, such as phenyl carbinol and methylphenyl carbinol; and phenolic compounds, such as phenol itself and substituted phenols wherein the substituents do not affect coating operations, such as cresol and nitrophenol. Glycol ethers and glycol amines may also be used as blocking agents. Suitable glycol ethers include ethylene glycol butyl ether, diethylene glycol butyl ether, ethylene glycol methyl ether and propylene glycol methyl ether. Other suitable blocking agents include oximes, such as methyl ethyl ketoxime, acetone oxime and cyclohexanone oxime. Other co-blocking agents include a 1,3-alkane diol, such as, for example, 1,3-butanediol; a benzylic alcohol, for example, benzyl alcohol; an allylic alcohol, for example, allyl alcohol; caprolactam; a dialkylamine, for example dibutylamine; other diol, triol, or polyols; and mixtures thereof.

The co-blocking agent may comprise at least 1% of the blocking groups of the blocked polyisocyanate curing agent, such as at least 5%, such as at least 10%, such as at least 15%, such as at least 20%, such as at least 25%, such as at least 30%, such as at least 45%, such as at least 50%, such as at least 55%, such as at least 60%, such as at least 65%, such as 70%, based upon the total number of blocking groups. The co-blocking agent may comprise no more than 70%, such as no more than 65%, such as no more than 60%, such as no more than 55%, such as no more than 50%, such as no more than 45%, such as no more than 40%, such as no more than 35%, such as no more than 30%, such as no more than 25%, such as no more than 20%, such as no more than 15%, such as no more than 10%, such as no more than 5%, such as no more than 1%, based upon the total number of blocking groups. The co-blocking agent may comprise 1% to 70%, such as 5% to 70%, such as 10% to 70%, such as 15% to 70%, such as 20% to 70%, such as 25% to 70%, such as 30% to 70%, such as 35% to 70%, such as 40% to 70%, such as 45% to 70%, such as 50% to 70%, such as 55% to 70%, such as 60% to 70%, such as 65% to 70%, such as 1% to 65%, such as 5% to 65%, such as 10% to 65%, such as 15% to 65%, such as 20% to 65%, such as 25% to 65%, such as 30% to 65%, such as 35% to 65%, such as 40% to 65%, such as 45% to 65%, such as 50% to 65%, such as 55% to 65%, such as 60% to 65%, such as 1% to 60%, such as 5% to 60%, such as 10% to 60%, such as 15% to 60%, such as 20% to 60%, such as 25% to 60%, such as 30% to 60%, such as 35% to 60%, such as 40% to 60%, such as 45% to 60%, such as 50% to 60%, such as 55% to 60%, such as 1% to 55%, such as 5% to 55%, such as 10% to 55%, such as 15% to 55%, such as 20% to 55%, such as 25% to 55%, such as 30% to 55%, such as 35% to 55%, such as 40% to 55%, such as 45% to 55%, such as 50% to 55%, such as 1% to 50%, such as 5% to 50%, such as 10% to 50%, such as 15% to 50%, such as 20% to 50%, such as 25% to 50%, such as 30% to 50%, such as 35% to 50%, such as 40% to 50%, such as 45% to 50%, such as 1% to 45%, such as 5% to 45%, such as 10% to 45%, such as 15% to 45%, such as 20% to 45%, such as 25% to 45%, such as 30% to 45%, such as 35% to 45%, such as 40% to 45%, such as 1% to 40%, such as 5% to 40%, such as 10% to 40%, such as 15% to 40%, such as 20% to 40%, such as 25% to 40%, such as 30% to 40%, such as 35% to 40%, such as 1% to 35%, such as 5% to 35%, such as 10% to 35%, such as 15% to 35%, such as 20% to 35%, such as 25% to 35%, such as 30% to 35%, such as 1% to 30%, such as 5% to 30%, such as 10% to 30%, such as 15% to 30%, such as 20% to 30%, such as 25% to 30%, such as 1% to 25%, such as 5% to 25%, such as 10% to 25%, such as 15% to 25%, such as 20% to 25%, such as 1% to 20%, such as 5% to 20%, such as 10% to 20%, such as 15% to 20%, such as 1% to 15%, such as 5% to 15%, such as 10% to 15%, such as 1% to 10%, such as 5% to 10%, such as 1% to 5%, based upon the total number of blocking groups.

The blocked polyisocyanate curing agent may be substantially free, essentially free, or completely free of blocking groups comprising a polyester diol blocking agent formed from the reaction of ethylene glycol, propylene glycol, or 1,4-butanediol with oxalic acid, succinic acid, adipic acid, suberic acid, or sebacic acid. The blocked polyisocyanate is substantially free of blocking groups comprising a polyester diol if such groups are present in an amount of 3% or less, based upon the total number of blocking groups. The blocked polyisocyanate is essentially free of blocking groups comprising a polyester diol if such groups are present in an amount of 1% or less, based upon the total number of blocking groups. The blocked polyisocyanate is completely free of blocking groups comprising a polyester diol is such groups are not present, i.e., 0%, based upon the total number of blocking groups.

The curing agent may be present in the cationic electrodepositable coating composition in an amount of at least 10% by weight, such as at least 20% by weight, such as at least 25% by weight and may be present in an amount of no more than 60% by weight, such as no more than 50% by weight, such as no more than 40% by weight, based on the total weight of the resin solids of the electrodepositable coating composition. The curing agent may be present in the cationic electrodepositable coating composition in an amount of 10% to 60% by weight, such as 20% to 50% by weight, such as 25% to 40% by weight, based on the total weight of the resin solids of the electrodepositable coating composition.

The curing agent may be present in the anionic electrodepositable coating composition in an amount of at least 10% by weight, such as at least 20% by weight, such as at least 25% by weight, and may be present in an amount of no more than 50% by weight, such as no more than 45% by weight, such as no more than 40% by weight, based on the total weight of the resin solids of the electrodepositable coating composition. The curing agent may be present in the anionic electrodepositable coating composition in an amount of 10% to 50% by weight, such as 20% to 45% by weight, such as 25% to 40% by weight, based on the total weight of the resin solids of the electrodepositable coating composition.

### Bismuth Catalyst

According to the present invention, the electrodepositable coating composition of the present invention comprises a bismuth catalyst.

As used herein, the term “bismuth catalyst” refers to catalysts that contain bismuth and catalyze transurethanation reactions, and specifically catalyze the deblocking of the blocked polyisocyanate curing agent blocking groups.

The bismuth catalyst may comprise a soluble bismuth catalyst. As used herein, a "soluble” or “solubilized” bismuth catalyst is at catalyst wherein at least 35% of the bismuth catalyst dissolves in an aqueous medium having a pH in the range of 4 to 7 at room temperature (e.g., 23° C.). The soluble bismuth catalyst may provide solubilized bismuth metal in an amount of at least 0.04% by weight, based on the total weight of the electrodepositable coating composition.

Alternatively, the bismuth catalyst may comprise an insoluble bismuth catalyst. As used herein, an “insoluble” bismuth catalyst is at catalyst wherein less than 35% of the catalyst dissolves in an aqueous medium having a pH in the range of 4 to 7 at room temperature (e.g., 23° C.). The insoluble bismuth catalyst may provide solubilized bismuth metal in an amount of less than 0.04% by weight, based on the total weight of the electrodepositable coating composition.

The percentage of solubilized bismuth catalyst present in the composition may be determined using ICP-MS to calculate the total amount of bismuth metal (i.e., soluble and insoluble) and total amount of solubilized bismuth metal and calculating the percentage using those measurements.

The bismuth catalyst may comprise a bismuth compound and/or complex.

The bismuth catalyst may, for example, comprise a colloidal bismuth oxide or bismuth hydroxide, a bismuth compound complex such as, for example, a bismuth chelate complex, or a bismuth salt of an inorganic or organic acid, wherein the term "bismuth salt" includes not only salts comprising bismuth cations and acid anions, but also bismuthoxy salts.

Examples of inorganic or organic acids from which the bismuth salts may be derived are hydrochloric acid, sulphuric acid, nitric acid, inorganic or organic sulphonic acids, carboxylic acids, for example, formic acid or acetic acid, amino carboxylic acids and hydroxy carboxylic acids, such as lactic acid or dimethylolpropionic acid.

Non-limiting examples of bismuth salts are aliphatic hydroxycarboxylic acid salts of bismuth, such as lactic acid salts or dimethylolpropionic acid salts of bismuth, for example, bismuth lactate or bismuth dimethylolpropionate; bismuth subnitrate; amidosulphonic acid salts of bismuth; hydrocarbylsulphonic acid salts of bismuth, such as alkyl sulphonic acid salts, including methane sulphonic acid salts of bismuth, for example, bismuth methane sulphonate. Further non-limiting examples of bismuth compound or complex catalysts include bismuth oxides, bismuth carboxylates, bismuth sulfamate, bismuth sulphonate, and combinations thereof.

The bismuth catalyst may be present in an amount of at least 0.01% by weight of bismuth metal, such as at least 0.1% by weight, such as at least 0.2% by weight, such as at least 0.5% by weight, such as at least 1% by weight, such as 1% by weight, based on the total resin solids weight of the composition. The bismuth catalyst may be present in an amount of no more than 3% by weight of bismuth metal, such as no more than 1.5% by weight, such as no more than 1% by weight, based on the total resin solids weight of the composition. The bismuth catalyst may be present in an amount of 0.01% to 3% by weight of bismuth metal, such as 0.1% to 1.5% by weight, such as 0.2% to 1% by weight, such as 0.5% to 3% by weight, such as 0.5% to 1.5% by weight, such as 0.5% to 1% by weight, such as 1% to 3% by weight, such as 1% to 1.5% by weight, based on the total resin solids weight of the composition.

== The bismuth catalyst may be present in an amount such that the amount of solubilized bismuth metal may be at least 0.04% by weight, based on the total weight of the electrodepositable coating composition, such as at least 0.06% by weight, such as at least 0.07% by weight, such as at least 0.08% by weight, such as at least 0.09% by weight, such as at least 0.10% by weight, such as at least 0.11% by weight, such as at least 0.12% by weight, such as at least 0.13% by weight, such as at least 0.14% by weight, or higher. The bismuth catalyst may be present in an amount such that the amount of solubilized bismuth metal of no more than 0.30% by weight, based on the total weight of the electrodepositable coating composition.

The bismuth catalyst may be present in an amount such that the amount of solubilized bismuth metal may be at least 0.22% by weight, based on the total weight of the resin solids, such as at least 0.30% by weight, such as at least 0.34% by weight, such at least 0.40% by weight, such as at least 0.45% by weight, such as 0.51% by weight, such as at least 0.56% by weight, such as at least 0.62% by weight, such as at least 0.68% by weight, such as at least 0.73% by weight, such as at least 0.80% by weight, or higher.

It has been surprisingly discovered that electrodepositable coating compositions that include the blocked polyisocyanate curing agent comprising blocking groups, wherein at least 30% of the blocking groups comprise a 1,2-polyol as a blocking agent, based upon the total number of blocking groups, and a bismuth catalyst produce a synergistic cure effect such that the compositions cure at low temperatures. For example, the electrodepositable coating compositions of the present invention may cure (T_{Cure}) at a temperature of less than 150° C., such as 140° C. or less, when measured by the DOUBLE RUB TEST METHOD (as defined in the Examples section below). For example, the electrodepositable coating compositions of the present invention may cure (T_{Cure}) at a temperature of less than 170° C., such as 160° C. or less, such as 155° C. or less, such as 150° C. or less, such as 145° C. or less, such as 142° C. or less, when measured by the TGA TEST METHOD (as defined in the Examples section below).

For example, the electrodepositable coating composition may cure at a temperature at least 10° C. lower than a comparative electrodepositable coating composition, such as at least 7° C. lower than a comparative electrodepositable coating composition, such as at least 5° C. lower than a comparative electrodepositable coating composition, such as at least 3° C. lower than a comparative electrodepositable coating composition, as measured by the DOUBLE RUB TEST METHOD. For example, the electrodepositable coating composition may cure at a temperature at least 10° C. lower than a comparative electrodepositable coating composition, such as at least 7° C. lower than a comparative electrodepositable coating composition, such as at least 5° C. lower than a comparative electrodepositable coating composition, such as at least 3° C. lower than a comparative electrodepositable coating composition, as measured by the TGA TEST METHOD. As used herein, a “comparative electrodepositable coating composition” is a composition having the same ionic-film-forming polymer and meets one of the following conditions: (1) a composition with the blocked polyisocyanate curing agent of the present invention with no catalyst; (2) a composition with the blocked polyisocyanate curing agent of the present invention with a catalyst other than a bismuth catalyst; (3) a composition with the blocked polyisocyanate curing agent of the present invention with a catalyst different than the bismuth catalyst of the present invention (including alternative forms of bismuth catalysts); or (4) a composition with a different blocked polyisocyanate curing agent than described here (i.e., without a 1,2-polyol blocking agent in the amount described herein) with or without a catalyst that may include a bismuth catalyst.

The bismuth catalyst is provided in an amount of at least 0.5% by weight bismuth metal, based on the total resin solids weight of the composition, and the 1,2-polyol may comprise a percentage of the blocking groups of the blocked polyisocyanate curing agent, the percentage being greater than or equal to [(-1.2x + 1.6)* 100]% or 30 %, whichever is higher, wherein x is the weight percent of bismuth metal, and the percentage of blocking groups is based upon the total number of blocking groups.

### Further Components of the Electrodepositable Coating Compositions

The electrodepositable coating composition according to the present invention may optionally comprise one or more further components in addition to the ionic salt group-containing film-forming polymer, the blocked polyisocyanate curing agent, and the bismuth catalyst described above.

According to the present invention, the electrodepositable coating composition may optionally comprise a co-catalyst to further catalyze the reaction between the blocked polyisocyanate curing agent and the film-forming polymers. Examples of co-catalysts suitable for cationic electrodepositable coating compositions include, without limitation, organotin compounds (e.g., dibutyltin oxide and dioctyltin oxide) and salts thereof (e.g., dibutyltin diacetate); other metal oxides (e.g., oxides of cerium and zirconium) and salts thereof; or a cyclic guanidine as described in U.S. Pat. No. 7,842,762 at col. 1, line 53 to col. 4, line 18 and col. 16, line 62 to col. 19, line 8, the cited portions of which being incorporated herein by reference. Examples of catalysts suitable for anionic electrodepositable coating compositions include latent acid catalysts, specific examples of which are identified in WO 2007/118024 at [0031] and include, but are not limited to, ammonium hexafluoroantimonate, quaternary salts of SbF₆ (e.g., NACURE® XC-7231), t-amine salts of SbF₆ (e.g., NACURE® XC-9223), Zn salts of triflic acid (e.g., NACURE® A202 and A218), quaternary salts of triflic acid (e.g., NACURE® XC-A230), and diethylamine salts of triflic acid (e.g., NACURE® A233), all commercially available from King Industries, and/or mixtures thereof. Latent acid catalysts may be formed by preparing a derivative of an acid catalyst such as para-toluenesulfonic acid (pTSA) or other sulfonic acids. For example, a well-known group of blocked acid catalysts are amine salts of aromatic sulfonic acids, such as pyridinium para-toluenesulfonate. Such sulfonate salts are less active than the free acid in promoting crosslinking. During cure, the catalysts may be activated by heating.

The co-catalyst may be present in the electrodepositable coating composition in amounts of 0.01% to 3% by weight, based on total weight of the resin solids of the electrodepositable coating composition.

Alternatively, the electrodepositable coating composition may be substantially free, essentially free, or completely free of a co-catalyst. As used herein, an electrodepositable coating composition is “substantially free” of a co-catalyst if the co-catalyst is present, if at all, in an amount less than 0.01% by weight, based on the total resin solids weight of the composition. As used herein, an electrodepositable coating composition is “essentially free” of a co-catalyst if the co-catalyst is present, if at all, in trace or incidental amounts insufficient to affect any properties of the composition, such as, e.g., less than 0.001% by weight, based on the total resin solids weight of the composition. As used herein, an electrodepositable coating composition is “substantially free” of a co-catalyst if the co-catalyst is not present in the composition, i.e., 0.000% by weight, based on the total resin solids weight of the composition.

The electrodepositable coating composition may be substantially free, essentially free, or completely free of tin. As used herein, an electrodepositable coating composition is “substantially free” of tin if tin is present, if at all, in an amount less than 0.01% by weight, based on the total resin solids weight of the composition. As used herein, an electrodepositable coating composition is "essentially free" of tin if tin is present, if at all, in trace or incidental amounts insufficient to affect any properties of the composition, such as, e.g., less than 0.001% by weight, based on the total resin solids weight of the composition. As used herein, an electrodepositable coating composition is “completely free” of tin if tin is not present in the composition, i.e., 0.000% by weight, based on the total resin solids weight of the composition.

The electrodepositable coating composition may be substantially free, essentially free, or completely free of bismuth subnitrate. As used herein, an electrodepositable coating composition is “substantially free” of bismuth subnitrate if bismuth subnitrate is present, if at all, in an amount less than 0.01% by weight, based on the total resin solids weight of the composition. As used herein, an electrodepositable coating composition is “essentially free” of bismuth subnitrate if bismuth subnitrate is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth subnitrate if bismuth subnitrate is not present in the composition, i.e., 0.000% by weight, based on the total resin solids weight of the composition.

The electrodepositable coating composition may be substantially free, essentially free, or completely free of bismuth oxide. As used herein, an electrodepositable coating composition is “substantially free” of bismuth oxide if bismuth oxide is present, if at all, in an amount less than 0.01% by weight, based on the total resin solids weight of the composition. As used herein, an electrodepositable coating composition is “essentially free” of bismuth oxide if bismuth oxide is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth oxide if bismuth oxide is not present in the composition, i.e., 0.000% by weight, based on the total resin solids weight of the composition.

The electrodepositable coating composition may be substantially free, essentially free, or completely free of bismuth silicate. As used herein, an electrodepositable coating composition is “substantially free” of bismuth silicate if bismuth silicate is present, if at all, in an amount less than 0.01% by weight, based on the total resin solids weight of the composition. As used herein, an electrodepositable coating composition is “essentially free” of bismuth silicate if bismuth silicate is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth silicate if bismuth silicate is not present in the composition, i.e., 0.000% by weight, based on the total resin solids weight of the composition.

The electrodepositable coating composition may be substantially free, essentially free, or completely free of bismuth titanate. As used herein, an electrodepositable coating composition is “substantially free” of bismuth titanate if bismuth titanate is present, if at all, in an amount less than 0.01% by weight, based on the total resin solids weight of the composition. As used herein, an electrodepositable coating composition is “essentially free” of bismuth titanate if bismuth titanate is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth titanate if bismuth titanate is not present in the composition, i.e., 0.000% by weight, based on the total resin solids weight of the composition.

The electrodepositable coating composition may be substantially free, essentially free, or completely free of bismuth sulfamate. As used herein, an electrodepositable coating composition is “substantially free” of bismuth sulfamate if bismuth sulfamate is present, if at all, in an amount less than 0.01% by weight, based on the total resin solids weight of the composition. As used herein, an electrodepositable coating composition is “essentially free” of bismuth sulfamate if bismuth sulfamate is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth sulfamate if bismuth sulfamate is not present in the composition, i.e., 0.000% by weight, based on the total resin solids weight of the composition.

The electrodepositable coating composition may be substantially free, essentially free, or completely free of bismuth lactate. As used herein, an electrodepositable coating composition is “substantially free” of bismuth lactate if bismuth lactate is present, if at all, in an amount less than 0.01% by weight, based on the total resin solids weight of the composition. As used herein, an electrodepositable coating composition is “essentially free” of bismuth lactate if bismuth lactate is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth lactate if bismuth lactate is not present in the composition, i.e., 0.000% by weight, based on the total resin solids weight of the composition.

According to the present invention, the electrodepositable coating composition may further comprise other optional ingredients, such as a pigment composition and, if desired, various additives such as fillers, anti-oxidants, biocides, UV light absorbers and stabilizers, hindered amine light stabilizers, defoamers, fungicides, dispersing aids, flow control agents, surfactants, wetting agents, crater-control additives, or combinations thereof. Alternatively, the electrodepositable coating composition may be completely free of any of the optional ingredients, i.e., the optional ingredient is not present in the electrodepositable coating composition. The pigment composition may comprise, for example, iron oxides, lead oxides, strontium chromate, carbon black, coal dust, titanium dioxide, talc, barium sulfate, as well as color pigments such as cadmium yellow, cadmium red, chromium yellow and the like. The pigment content of the dispersion may be expressed as the pigment-to-resin weight ratio and may be within the range of 0.03 to 0.6, when pigment is used. The other additives mentioned above may each independently be present in the electrodepositable coating composition in amounts of 0.01% to 3% by weight, based on total weight of the resin solids of the electrodepositable coating composition.

According to the present invention, the electrodepositable coating composition may further comprise a plasticizer. The plasticizer may be any suitable plasticizer. The plasticizer may comprise, for example, a polyalkylene glycol, such as polyethylene glycol, polypropylene glycol, or polybutylene glycol. The polyalkylene glycol may comprise two secondary hydroxyl functional groups. The plasticizer may have a molecular weight of at least 400 g/mol, such as at least 500 g/mol, such as at least 700 g/mol. The plasticizer may have a molecular weight of no more 5,000 g/mol, such as no more than 1,000 g/mol, such as no more than 800 g/mol. The plasticizer may have a molecular weight of 400 to 5,000 g/mol, such as 400 to 1,000 g/mol, such as 400 to 800 g/mol, such as 500 to 5,000 g/mol, such as 500 to 1,000 g/mol, such as 500 to 800 g/mol, such as 700 to 5,000 g/mol, such as 700 to 1,000 g/mol, such as 700 to 800 g/mol.

According to the present invention, the electrodepositable coating composition may comprise water and/or one or more organic solvent(s). Water can for example be present in amounts of 40% to 90% by weight, such as 50% to 75% by weight, based on total weight of the electrodepositable coating composition. Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic solvents may typically be present in an amount of less than 10% by weight, such as less than 5% by weight, based on total weight of the electrodepositable coating composition. The electrodepositable coating composition may in particular be provided in the form of a dispersion, such as an aqueous dispersion.

According to the present invention, the total solids content of the electrodepositable coating composition may be at least 1% by weight, such as at least 5% by weight, and may be no more than 50% by weight, such as no more than 40% by weight, such as no more than 20% by weight, based on the total weight of the electrodepositable coating composition. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

### Substrates

According to the present invention, the electrodepositable coating composition may be electrophoretically applied to a substrate. The cationic electrodepositable coating composition may be electrophoretically deposited upon any electrically conductive substrate. Suitable substrates include metal substrates, metal alloy substrates, and/or substrates that have been metallized, such as nickel-plated plastic. Additionally, substrates may comprise non-metal conductive materials including composite materials such as, for example, materials comprising carbon fibers or conductive carbon. According to the present invention, the metal or metal alloy may comprise cold rolled steel, hot rolled steel, steel coated with zinc metal, zinc compounds, or zinc alloys, such as electrogalvanized steel, hot-dipped galvanized steel, galvanealed steel, and steel plated with zinc alloy. Aluminum alloys of the 2XXX, 5XXX, 6XXX, or 7XXX series as well as clad aluminum alloys and cast aluminum alloys of the A356 series also may be used as the substrate. Magnesium alloys of the AZ31B, AZ91C, AM60B, or EV31A series also may be used as the substrate. The substrate used in the present invention may also comprise titanium and/or titanium alloys. Other suitable non-ferrous metals include copper and magnesium, as well as alloys of these materials. Suitable metal substrates for use in the present invention include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091.

In examples, the substrate may comprise a three-dimensional component formed by an additive manufacturing process such as selective laser melting, e-beam melting, directed energy deposition, binder jetting, metal extrusion, and the like. In examples, the three-dimensional component may be a metal and/or resinous component.

### Methods of Coating, Coatings and Coated Substrates

The present invention is also directed to methods for coating a substrate, such as any one of the electroconductive substrates mentioned above. According the present invention such method may comprise electrophoretically applying an electrodepositable coating composition as described above to at least a portion of the substrate and curing the coating composition to form an at least partially cured coating on the substrate. According to the present invention, the method may comprise (a) electrophoretically depositing onto at least a portion of the substrate an electrodepositable coating composition of the present invention and (b) heating the coated substrate to a temperature and for a time sufficient to cure the electrodeposited coating on the substrate. According to the present invention, the method may optionally further comprise (c) applying directly to the at least partially cured electrodeposited coating one or more pigment-containing coating compositions and/or one or more pigment-free coating compositions to form a top coat over at least a portion of the at least partially cured electrodeposited coating, and (d) heating the coated substrate of step (c) to a temperature and for a time sufficient to cure the top coat.

According to the present invention, the cationic electrodepositable coating composition of the present invention may be deposited upon an electrically conductive substrate by placing the composition in contact with an electrically conductive cathode and an electrically conductive anode, with the surface to be coated being the cathode. Following contact with the composition, an adherent film of the coating composition is deposited on the cathode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the cationic electrodepositable coating composition is electrodeposited over at least a portion of the electroconductive substrate, the coated substrate is heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. As discussed above, the electrodepositable coating composition is capable of curing at surprisingly low temperature. The coated substrate may be heated to a temperature ranging from 250° F. to 450° F. (121.1° C. to 232.2° C.), such as from 275° F. to 400° F. (135° C. to 204.4° C.), such as from 284° F. to 360° F. (140° C. to 180° C.), such as less than 302° F. (150° C.), such as less than 284° F. (140° C.). The curing time may be dependent upon the curing temperature as well as other variables, for example, the film thickness of the electrodeposited coating, level and type of catalyst present in the composition and the like. For purposes of the present invention, all that is necessary is that the time be sufficient to effect cure of the coating on the substrate. For example, the curing time can range from 10 minutes to 60 minutes, such as 20 to 40 minutes. The thickness of the resultant cured electrodeposited coating may range from 15 to 50 microns.

According to the present invention, the anionic electrodepositable coating composition of the present invention may be deposited upon an electrically conductive substrate by placing the composition in contact with an electrically conductive cathode and an electrically conductive anode, with the surface to be coated being the anode. Following contact with the composition, an adherent film of the coating composition is deposited on the anode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the anionic electrodepositable coating composition is electrodeposited over at least a portion of the electroconductive substrate, the coated substrate may be heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. As discussed above, the electrodepositable coating composition is capable of curing at surprisingly low temperature. The coated substrate may be heated to a temperature ranging from 200° F. to 450° F. (93° C. to 232.2° C.), such as from 275° F. to 400° F. (135° C. to 204.4° C.), such as from 284° F. to 360° F. (140° C. to 180° C.), such as less than 302° F. (150° C.), such as less than 284° F. (140° C.). The curing time may be dependent upon the curing temperature as well as other variables, for example, film thickness of the electrodeposited coating, level and type of catalyst present in the composition and the like. For purposes of the present invention, all that is necessary is that the time be sufficient to effect cure of the coating on the substrate. For example, the curing time may range from 10 to 60 minutes, such as 20 to 40 minutes. The thickness of the resultant cured electrodeposited coating may range from 15 to 50 microns.

The electrodepositable coating compositions of the present invention may also, if desired, be applied to a substrate using non-electrophoretic coating application techniques, such as flow, dip, spray and roll coating applications. For non-electrophoretic coating applications, the coating compositions may be applied to conductive substrates as well as non-conductive substrates such as glass, wood and plastic.

The present invention is further directed to a coating formed by at least partially curing the electrodepositable coating composition described herein.

The present invention is further directed to a substrate that is coated, at least in part, with the electrodepositable coating composition described herein in an at least partially cured state.

### Multi-Layer Coating Composites

The electrodepositable coating compositions of the present invention may be utilized in an electrocoating layer that is part of a multi-layer coating composite comprising a substrate with various coating layers. The coating layers may include a pretreatment layer, such as a phosphate layer (e.g., zinc phosphate layer), an electrocoating layer which results from the electrodepositable coating composition of the present invention, and suitable top coat layers (e.g., base coat, clear coat layer, pigmented monocoat, and color-plus-clear composite compositions). It is understood that suitable topcoat layers include any of those known in the art, and each independently may be waterborne, solventborne, in solid particulate form (i.e., a powder coating composition), or in the form of a powder slurry. The top coat typically includes a film-forming polymer, crosslinking material and, if a colored base coat or monocoat, one or more pigments. According to the present invention, the primer layer is disposed between the electrocoating layer and the base coat layer. According to the present invention, one or more of the topcoat layers are applied onto a substantially uncured underlying layer. For example, a clear coat layer may be applied onto at least a portion of a substantially uncured basecoat layer (wet-on-wet), and both layers may be simultaneously cured in a downstream process.

Moreover, the top-coat layers may be applied directly onto the electrodepositable coating layer. In other words, the substrate lacks a primer layer. For example, a basecoat layer may be applied directly onto at least a portion of the electrodepositable coating layer.

It will also be understood that the top-coat layers may be applied onto an underlying layer despite the fact that the underlying layer has not been fully cured. For example, a clearcoat layer may be applied onto a basecoat layer even though the basecoat layer has not been subjected to a curing step. Both layers may then be cured during a subsequent curing step thereby eliminating the need to cure the basecoat layer and the clearcoat layer separately.

According to the present invention, additional ingredients such as colorants and fillers may be present in the various coating compositions from which the top-coat layers result. Any suitable colorants and fillers may be used. For example, the colorant may be added to the coating in any suitable form, such as discrete particles, dispersions, solutions and/or flakes. A single colorant or a mixture of two or more colorants can be used in the coatings of the present invention. It should be noted that, in general, the colorant can be present in a layer of the multi-layer composite in any amount sufficient to impart the desired property, visual and/or color effect.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant may be organic or inorganic and may be agglomerated or non-agglomerated. Colorants may be incorporated into the coatings by grinding or simple mixing. Colorants may be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red ("DPP red BO"), titanium dioxide, carbon black, zinc oxide, antimony oxide, etc. and organic or inorganic UV opacifying pigments such as iron oxide, transparent red or yellow iron oxide, phthalocyanine blue and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

The colorant may be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions may include colorants such as pigments or dyes having a particle size of less than 150 nm, such as less than 70 nm, or less than 30 nm. Nanoparticles may be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions may also be produced by crystallization, precipitation, gas phase condensation, and chemical attrition (i.e., partial dissolution). In order to minimize re-agglomeration of nanoparticles within the coating, a dispersion of resin-coated nanoparticles may be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. Pat. Application No. 10/876,031 filed Jun. 24, 2004, which is incorporated herein by reference, and U.S. Provisional Pat. Application No. 60/482,167 filed Jun. 24, 2003, which is also incorporated herein by reference.

According to the present invention, special effect compositions that may be used in one or more layers of the multi-layer coating composite include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions may provide other perceptible properties, such as reflectivity, opacity or texture. For example, special effect compositions may produce a color shift, such that the color of the coating changes when the coating is viewed at different angles. Example color effect compositions are identified in U.S. Pat. No. 6,894,086, incorporated herein by reference. Additional color effect compositions may include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

According to the present invention, a photosensitive composition and/or photochromic composition, which reversibly alters its color when exposed to one or more light sources, can be used in a number of layers in the multi-layer composite. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. For example, the photochromic and/or photosensitive composition may be colorless in a non-excited state and exhibit a color in an excited state. Full color-change may appear within milliseconds to several minutes, such as from 20 seconds to 60 seconds. Example photochromic and/or photosensitive compositions include photochromic dyes.

According to the present invention, the photosensitive composition and/or photochromic composition may be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with the present invention, have minimal migration out of the coating. Example photosensitive compositions and/or photochromic compositions and methods for making them are identified in U.S. Pat. Application No. 10/892,919 filed Jul. 16, 2004 and incorporated herein by reference.

As used herein, the term “resin solids” include the ionic salt group-containing film-forming polymer, the blocked polyisocyanate curing agent, and any additional water-dispersible non-pigmented component(s) present in the electrodepositable coating composition.

As used herein, the term “polymer” encompasses, but is not limited to, oligomers and both homopolymers and copolymers.

As used herein, unless otherwise defined, the term substantially free means that the component is present, if at all, in an amount of less than 5% by weight, based on the total weight of the slurry composition.

As used herein, unless otherwise defined, the term essentially free means that the component is present, if at all, in an amount of less than 1% by weight, based on the total weight of the slurry composition.

As used herein, unless otherwise defined, the term completely free means that the component is not present in the slurry composition, i.e., 0.00% by weight, based on the total weight of the slurry composition.

For purposes of this detailed description, it is to be understood that the invention may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of "1 to 10" is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

In this application, the use of the singular includes the plural and plural encompasses singular, unless specifically stated otherwise. For example, although reference is made herein to “an” ionic salt group-containing film-forming polymer, “a” blocked polyisocyanate curing agent, and/or “a” bismuth catalyst, a combination (i.e., a plurality) of these components may be used. In addition, in this application, the use of “or” means “and/or” unless specifically stated otherwise, even though “/or” may be explicitly used in certain instances.

Whereas specific aspects of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

Illustrating the invention are the following examples, which, however, are not to be considered as limiting the invention to their details. Unless otherwise indicated, all parts and percentages in the following examples, as well as throughout the specification, are by weight.

### EXAMPLES

### Example 1: Preparation of a Blocked Polyisocyanate Curing Agent Comprising Isocyanato Groups Blocked with a 1,2-Polyol Blocking Agent (Crosslinkers I and Ia-g)

Blocked polyisocyanate curing agent comprising isocyanato groups blocked with a 1,2-polyol (Crosslinker I and Ia through Ig) were prepared in the following manner: Components 2-7 listed in Table 1, below, were mixed in a flask set up for total reflux with stirring under nitrogen. The mixture was heated to a temperature of 30° C., and Component 1 was added dropwise so that the temperature increased due to the reaction exotherm and was maintained under 100° C. After the addition of Component 1 was complete, a temperature of 100° C. was established in the reaction mixture and the reaction mixture held at temperature until no residual isocyanate was detected by IR spectroscopy. Components 8-9 were then added, and the reaction mixture was allowed to stir for 30 minutes at 100° C. before cooling to ambient temperature.

Table 1

| | | Parts by Weight | | | | | | | |
|---|---|---|---|---|---|---|---|---|---|
| No. | Component | I | Ia | Ib | Ic | Id | Comp. Ie | If | Ig |
| 1 | Polymeric methylene diphenyl diisocyanate¹ | 1340.00 | 3999.18 | 3969.1 | 1377.1 | 1134.0 | 1320.1 | 601.0 | 1377.1 |
| 2 | Dibutyltin dilaurate | 1.05 | 3.13 | 3.37 | 1.26 | 1.11 | 1.4 | 0.5 | 1.30 |
| 3 | Methyl isobutyl ketone | 213.10 | 635.99 | 1091.5 | 406.7 | 334.9 | 445.5 | 165.0 | 406.7 |
| 4 | Propylene glycol | 760.00 | 2268.19 | 1800.9 | 468.6 | 257.3 | 149.7 | - | - |
| 5 | Diethylene glycol monobutyl ether | - | - | 961.1 | 665.9 | 822.6 | 1276.8 | - | - |
| 6 | 1,2-butane diol | - | - | - | - | - | - | 403.0 | - |
| 7 | 1,2-hexane diol | - | - | - | - | - | - | - | 1214.4 |
| 8 | Methyl isobutyl ketone | 322.90 | 963.68 | 121.3 | 45.9 | 64.1 | 49.5 | 18.0 | 60.4 |
| 9 | Butyl carbitol formal | 43.50 | 129.82 | 139.7 | 52.1 | 45.9 | 56.9 | 21.0 | 53.7 |

¹ Rubinate M, available from Huntsman Corporation.

### Example 2: Preparation of a Comparative Blocked Polyisocyanate Curing Agent (Crosslinker II and IIa-b)

Comparative blocked polyisocyanate curings agent that does not include blocking groups blocked with a 1,2-polyol (Crosslinkers IIa-b) was prepared in the following manner: Components 2-6 listed in Table 2, below, were mixed in a flask set up for total reflux with stirring under nitrogen. The mixture was heated to a temperature of 30° C., and Component 1 was added dropwise so that the temperature increased due to the reaction exotherm and was maintained under 100° C. After the addition of Component 1 was complete, a temperature of 100° C. was established in the reaction mixture and the reaction mixture held at temperature until no residual isocyanate was detected by IR spectroscopy. Components 7-8 were then added, and the reaction mixture was allowed to stir for 30 minutes before cooling to ambient temperature.

Table 2

| | | Parts by Weight | | |
|---|---|---|---|---|
| No. | Component | Comp. II | Comp. IIa | Comp. IIb |
| 1 | Polymeric methylene diphenyl diisocyanate¹ | 1340.00 | 1340.0 | 1545.5 |
| 2 | Dibutyltin dilaurate | 2.61 | 2.96 | 1.29 |
| 3 | Methyl isobutyl ketone | 234.29 | 200.0 | 419.7 |
| 4 | Diethylene glycol monobutyl ether | 324.46 | 1622.3 | - |
| 5 | Ethylene glycol monobutyl ether | 945.44 | - | - |
| 6 | 1,3-Butane diol | - | - | 1039.4 |
| 7 | Methyl isobutyl ketone | 88.60 | 165.0 | 46.0 |
| 8 | Butyl Carbitol Formal | - | - | 53.6 |

¹ Rubinate M, available from Huntsman Corporation.

### Example 3: Preparation of a Cationic, Amine-Functionalized, Polyepoxide-Based Resin Comprising Crosslinker Ia-g (Resin Dispersion la-g)

A cationic, amine-functionalized, polyepoxide-based polymeric resin was prepared in the following manner. Components 1-5 listed in Table 3, below, were mixed in a flask set up for total reflux with stirring under nitrogen. The mixture was heated to a temperature of 130° C. and allowed to exotherm (175° C. maximum). A temperature of 145° C. was established in the reaction mixture and the reaction mixture was then held for 2 hours. Component 6 was introduced slowly while allowing the mixture to cool to 125° C. followed by the addition of Component 7. A temperature of 105° C. was established, and Components 8 and 9 were then added to the reaction mixture quickly (sequential addition) and the reaction mixture was allowed to exotherm. A temperature of 120° C. was established and the reaction mixture held for 1 hour, resulting in Resin Synthesis Products Ia-g.

Table 3

| | Resin | I | Ia | Ib | Ic | Id | Comp. Ie | If | Ig |
|---|---|---|---|---|---|---|---|---|---|
| No. | Component | Resin Synthesis Stage Parts-by-weight (grams) | | | | | | | |
| 1 | Bisphenol A diglycidyl ether ¹ | 1083.00 | 637.06 | 637.06 | 637.06 | 637.06 | 637.06 | 637.06 | 637.06 |
| 2 | Bisphenol A | 467.64 | 275.08 | 275.08 | 275.08 | 275.08 | 275.08 | 275.08 | 275.08 |
| 3 | Bisphenol A -ethylene oxide adduct (⅙ molar ratio BPA/EtO) | 316.88 | 186.40 | 193.40 | 199.800 | 206.50 | 213.60 | 192.00 | 203.10 |
| 4 | Methyl isobutyl ketone (MIBK) | 57.76 | 33.98 | 34.19 | 34.390 | 34.60 | 34.82 | 34.15 | 34.49 |
| 5 | Ethyl triphenyl phosphonium bromide | 1.70 | 1.00 | 1.00 | 1.00 | 1.00 | 1.00 | 1.00 | 1.00 |
| 6 | Methyl isobutyl ketone | 15.69 | 9.23 | 54.91 | 53.374 | 51.66 | 49.97 | 55.24 | 52.54 |
| 7 | Crosslinker Ia-g² | 1369.17 | 805.39 | 829.48 | 894.256 | 965.33 | 1036.82 | 815.44 | 928.85 |
| 8 | Diethylene triamine -MIBK diketimine ³ | 100.44 | 59.08 | 59.08 | 59.085 | 59.08 | 59.08 | 59.08 | 59.08 |
| 9 | Methyl ethanol amine | 85.77 | 50.45 | 50.45 | 50.45 | 50.45 | 50.45 | 50.45 | 50.45 |

Resin Dispersion Stage

| | | | | | | | | | |
|---|---|---|---|---|---|---|---|---|---|
| 10 | Resin Synthesis Product Ia-g | 3146.71 | 1851.01 | 1834.95 | 1939.07 | 2097.38 | 2121.19 | 1821.91 | 1926.97 |
| 11 | Sulfamic acid | 82.94 | - | - | - | - | - | - | - |
| 12 | Formic acid (90% solution in water) | - | 25.32 | 25.10 | 26.53 | 28.71 | 29.01 | 24.92 | 26.35 |
| 13 | Deionized water | 1955.89 | 1126.72 | 1116.94 | 1180.33 | 1276.70 | 1291.17 | 1109.00 | 1172.95 |
| 14 | Deionized water | 2319.85 | 1343.47 | 1331.81 | 1407.39 | 1522.30 | 1539.56 | 1322.35 | 1398.60 |
| 15 | Deionized water | 2000.00 | 1000.00 | 1000.00 | 1000.00 | 1000.00 | 1000.00 | 1000.00 | 1000.00 |

Dispersion Solids (wt%)

| | | | | | | | |
|---|---|---|---|---|---|---|---|
| 38.17% | 41.3% | 39.34% | 39.9% | 40.05% | 42.10% | 39.72% | 35.70% |

¹ EPON 828, available from Hexion Corporation.
² See Example 1, above. Resin Ia uses Crosslinker Ia, Resin Ib uses Crosslinker Ib, Resin Ic uses Crosslinker Ic, Resin Id uses Crosslinker Id, Resin Ie uses Crosslinker Ie, Resin If uses Crosslinker If, and Resin Ig uses Crosslinker Ig.
³ 72.7% by weight (in MIBK) of the diketimine reaction product of 1 equivalent of diethylene triamine and 2 equivalents of MIBK.

A portion of the Resin Synthesis Product Ia-g (Component 10) was then poured into a pre-mixed solution of Components 11-13 to form a resin dispersion, and the resin dispersion was stirred for 1 hour. Component 14 was then introduced over 30 minutes to further dilute the resin dispersion, followed by the addition of Component 15. The free MIBK in the resin dispersion was removed from the dispersion under vacuum at a temperature of 60-70° C.

The solids content of the resulting cationic, amine-functionalized, polyepoxide-based polymeric resin dispersion, comprising a 1,2-polyol-based crosslinker added during the resin synthesis stage (Inventive Resin Dispersion Ia-g), was determined by adding a quantity of the resin dispersion to a tared aluminum dish, recording the initial weight of the resin dispersion, heating the resin dispersion in the dish for 60 minutes at 110° C. in an oven, allowing the dish to cool to ambient temperature, reweighing the dish to determine the amount of non-volatile content remaining, and calculating the solids content by dividing the weight of the remaining non-volatile content by the initial resin dispersion weight and multiplying by 100. (Note, this procedure was used to determine the solids content in each of resin dispersion examples described below). The solids contents of Resin Dispersions Ia-g are reported in Table 3.

### Example 4: Preparation of a Comparative Cationic, Amine-Functionalized, Polyepoxide-Based Resin (Comparative Resin Dispersions IIa-b)

A cationic, amine-functionalized, polyepoxide-based polymeric resin was prepared in the following manner: Components 1-5 listed in Table 4, below, were mixed in a flask set up for total reflux with stirring under nitrogen. The mixture was heated to a temperature of 130° C. and allowed to exotherm (175° C. maximum). A temperature of 145° C. was established in the reaction mixture and the reaction mixture was then held for 2 hours. Component 6 was introduced slowly while allowing the mixture to cool to 125° C. followed by the addition of Components 7 and 8. A temperature of 105° C. was established, and Components 9 and 10 were then added to the reaction mixture quickly (sequential addition) and the reaction mixture was allowed to exotherm. A temperature of 120° C. was established and the reaction mixture held for 1 hour, resulting in Comparative Resin Synthesis Product IIa-b.

Table 4

| | Resin | Comp. II | Comp. IIa | Comp. IIb |
|---|---|---|---|---|
| No. | Component | Parts-by-weight (grams) | | |
| 1 | Bisphenol A diglycidyl ether ¹ | 509.65 | 637.06 | 637.06 |
| 2 | Bisphenol A | 220.07 | 275.08 | 275.08 |
| 3 | Bisphenol A - ethylene oxide adduct (⅙ molar ratio BPA/EtO) | 172.16 | 216.50 | 192.20 |
| 4 | Methyl isobutyl ketone (MIBK) | 27.89 | 34.91 | 34.15 |
| 5 | Ethyl triphenyl phosphonium bromide | 0.80 | 1.00 | 1.00 |
| 6 | Methyl isobutyl ketone | 129.99 | 97.18 | 55.23 |
| 7 | Crosslinker IIa-b ² | 752.71 | 1017.61 | 816.31 |
| 8 | Butyl carbitol formal | 13.88 | - | - |
| 9 | Diethylene triamine - MIBK diketimine ³ | 47.27 | 59.08 | 59.08 |
| 10 | Methyl ethanolamine | 40.36 | 50.45 | 50.45 |
| Resin Dispersion Stage | | | | |
| 11 | Resin Synthesis Product IIa-b | 1634.30 | 2101.33 | 1865.22 |
| 12 | Sulfamic acid | 44.17 | - | - |
| 13 | Formic acid (90% solution in water) | - | 28.75 | 25.55 |
| 14 | Deionized water | 1027.17 | 1279.09 | 1135.39 |
| 15 | Deionized water | 1232.78 | 1525.16 | 1353.81 |
| 16 | Deionized water | 1100.00 | 1000.00 | 1000.00 |
| Dispersion Solids (wt %) | | | | |
| | | 38.68% | 39.12% | 39.6% |

¹ EPON 828, available from Hexion Corporation.
² See Example 2, above. Resin IIa uses Crosslinker IIa, and Resin IIb uses Crosslinker IIb.
³ 72.7% by weight (in MIBK) of the diketimine reaction product of 1 equivalent of diethylene triamine and 2 equivalents of MIBK.

A portion of the Comparative Resin Synthesis Product IIa-b (Component 11) was then poured into a pre-mixed solution of Components 12-14 to form a resin dispersion, and the resin dispersion was stirred for 1 hour. Component 15 was then introduced over 30 minutes to further dilute the resin dispersion, followed by the addition of Component 16. The free MIBK in the resin dispersion was removed from the dispersion under vacuum at a temperature of 60-70° C. The solids contents of Resin Dispersions IIa-b are reported in Table 4.

Example 5: Preparation of a Cationic Resin Containing Jeffamine D2000 (Cationic Resin Va-Vb)

Table 5

| | Resin | Va | Vb |
|---|---|---|---|
| No. | Component | Parts-by-weight (grams) | |
| 1 | EPON 828 | 752 | 241.1 |
| 2 | Bisphenol A | 228 | 73.5 |
| 3 | Butyl Carbitol formal | 108.89 | 35.1 |
| 4 | Ethyl triphenyl phosphonium iodide | 0.752 | 0.2 |
| 5 | Butyl Carbitol formal | 298.63 | 60.1 |
| 6 | JEFFAMINE D2000 ¹ | 2687.74 | 855.4 |
| 7 | Butyl Carbitol formal | - | 26.1 |
| 8 | Rhodameen C5 ² | - | 65.1 |
| 9 | Butyl Carbitol formal | - | 10.1 |
| 10 | Sulfamic acid | 131.93 | - |
| 11 | Lactic acid | - | 43.5 |
| 12 | Deionized water | 7812.62 | 1322.7 |
| 13 | Deionized water | - | 303.7 |

¹ A polypropylene oxide resin terminated with primary amines available from Huntsman Chemical
² A surfactant available from Solvay

A cationic resin was prepared in the following manner from the materials included in Table 5: Materials 1, 2, and 3 were added to a suitably equipped round bottom flask. The mixture is then heated to 125° C. Material 4 was then added. The reaction mixture was allowed to exotherm, after which the mixture was heated to 160° C. The reaction mixture was then held at 160-170° C. for 1hr. Material 5 was then added and mixed well. Material 6 was then added, and the mixture was allowed to exotherm. Material 7 was then added and mixed well. The resulting reaction mixture was heated to 130° C., and held for 3 hrs. Material 8 was then added, followed by Material 9, and the mixture was stirred for 10 min. Materials 10-12 were pre-blended in a container, and the reaction mixture was added to the acidic water solution under agitation to form a cationic dispersion. The dispersion was stirred for 30 min, then Material 13 was added.

Example 6: Preparation of a Cationic Resin Intermediate (Intermediate VIa-VIb)

Table 6

| | Resin | VIa | VIb |
|---|---|---|---|
| # | Material | Parts by Weight (grams) | |
| 1 | EPON 828 | 8940.2 | 1023 |
| 2 | Bisphenol A-ethylene oxide adduct¹ | 3242.1 | 365 |
| 3 | Bisphenol A | 2795.8 | 297 |
| 4 | Methyl isobutyl ketone | 781.8 | - |
| 5 | Tetronic 150R1 ² | 8.1 | - |
| 6 | 2-Butoxyethanol | - | 187.2 |
| 7 | Benzyldimethylamine | 12.4 | 1.4 |
| 8 | Benzyldimethylamine | 18.24 | 3.0 |
| 9 | Diketimine³ | 1623.6 | 182.3 |
| 10 | N-methylethanolamine | 758.7 | 85.2 |
| 11 | Sulfamic acid | 1524.4 | - |
| 12 | Acetic acid | - | 105.9 |
| 13 | Deionized water | 12561 | 1065.9 |
| 14 | Deionized water | 7170.3 | 735.9 |
| 15 | Deionized water | 11267.7 | 1156.4 |
| 16 | Deionized water | 8450.7 | 867.3 |

¹ A 6 mole ethoxylate of Bisphenol A.
² Tetronic 150R1 is a nonionic surfactant available from BASF.
³ Diketimine is the reaction product of diethylene triamine and Methyl isobutyl ketone at 72.3% solids in methyl isobutyl ketone.

A cationic resin intermediate was prepared in the following manner from the materials included in Table 6: Materials 1-6 were charged into a reaction vessel and heated under a nitrogen atmosphere to 125° C. Material 7 was added and the reaction was allowed to exotherm to around 180° C. When the reaction reached 160° C., a one-hour hold was started. After the peak exotherm, the resin was allowed to cool back to 160° C., continuing the hold. After the hold, the reaction was then cooled to 130° C., and Material 8 was added. The reaction was held at 130° C. until an extrapolated epoxy equivalent weight of 1,070 as measured using a Metrohm 799 MPT Titrino automatic titrator utilizing a 1 M perchloric acid solution in acetic acid. At the expected epoxy equivalent weight, Materials 9-10 were added in succession, and the mixture was allowed to exotherm to around 150° C. At the peak exotherm, a one-hour hold was started while allowing the reaction to cool to 125° C. After the one-hour hold, the resin was dispersed in an aqueous medium consisting of Materials 11-13. The dispersion was later reduced with Materials 14-16 in succession. Solvent was removed from the resulting cationic resin intermediate by vacuum distillation until the methyl isobutyl ketone content was less than 0.05% as measured by gas chromatography.

Example 7: Preparation of a Cationic Resin Containing Intermediate VIa-VIb (Cationic Resin VIIa-VIIb)

Table 7

| | Resin | VIIa | VIIb |
|---|---|---|---|
| # | Material | Parts by Weight (grams) | |
| 1 | Intermediate VIa-VIb ¹ | 50.10 | 2517 |
| 2 | Propylene glycol monopropyl ether | 1.34 | - |
| 3 | Deionized water | 1.47 | 443 |
| 4 | EPON 828 solution² | 781.8 | 44.8 |
| 5 | 2-Butoxyethanol | 1.34 | - |
| 6 | Methyl isobutyl ketone | - | 4.05 |
| 7 | Rhodameen C5 ³ | 1.98 | - |
| 8 | Deionized water | 0.93 | - |
| 9 | Deionized water | 4.00 | 14.97 |
| 10 | Deionized water | 14.97 | - |

¹ Cationic resin VIIa uses intermediate VIa, and cationic resin VIIb uses intermediate VIb.
² 85% EPON 828 (Epoxy resin available from Hexion Chemicals) + 15% solvent. For cationic resin VIIa, solvent is propylene glycol methyl ether, and for cationic resin VIIb, solvent is methyl isobutyl ketone.
³ A surfactant available from Solvay.

A cationic resin was prepared in the following manner from the materials included in Table 7. Materials 1-3 were charged to the reactor and heated to 70° C. Material 4 was added over 15 min and mixed well. Materials 5-6 were added, and the mixture was held at 70° C. for 45 minutes. The mixture was then heated to 88-90° C. and held at this temperature for 3 hr. Two and one-half hours into the hold, Materials 7-8 were added. At the end of the hold, heat was removed, and Material 9 was added. The mixture was then cooled. Material 10 was added once the temperature reached 32° C., and the mixture was held for 1 hr while continuing to cool, yielding Cationic Resin VIIa-b.

Example 8: Preparation of Grind Vehicle 1

Table 8

| # | Material | Parts (g) |
|---|---|---|
| 1 | EPON 828¹ | 533.2 |
| 2 | Nonyl phenol | 19.1 |
| 3 | Bisphenol A | 198.3 |
| 4 | Ethyltriphenyl phosphonium iodide | 0.7 |
| 5 | Butoxy propanol | 99.3 |
| | Subtotal | 850.6 |
| 6 | Butoxy propanol | 93.9 |
| 7 | Methoxy propanol | 50.3 |
| | Subtotal | 994.8 |
| 8 | Thiodiethanol | 121.3 |
| 9 | Butoxy propanol | 6.9 |
| 10 | Deionized water | 32.1 |
| 11 | Dimethylol propionic acid | 133.1 |
| | Subtotal | 1288.2 |
| 12 | Deionized water | 1100 |
| 13 | Deionized water | 790 |

¹ Diglycidyl ether of Bisphenol A commercially available from Resolution Chemical Co as Epon 828.

Grind Vehicle 1 was prepared with the materials listed in Table 8 according to the following procedure: Materials 1 through 5 were charged to a suitably equipped flask and heat to 125° C. The mixture was allowed to exotherm to 175° C. and then held at 160-165° C. for 1 hr. After the 1-hour hold, Materials 6-7 were added. The mixture was then cooled to 80° C. and Materials 8-11 were added. The mixture was held at 78° C. until the measured acid value was less than 2, as measured using a Metrohm 799 MPT Titrino automatic titrator utilizing a 0.1 M potassium hydroxide solution in methanol. Then 1288.2 g of the resin was poured into 1100 g of deionized water (Material 12) with stirring. The mixture was mixed for 30 minutes before material 13 was added and mixed well.

### Example 9: Preparation of Grind Vehicle 2

This example describes the preparation of a quaternary ammonium salt containing pigment-grinding resin, Grind Vehicle 2. Grind Vehicle 2-1 describes the preparation of an amine-acid salt quaternizing agent and Grind Vehicle 2-2 describes the preparation of an epoxy group-containing polymer that is subsequently quaternized with the amine-acid salt of Grind Vehicle 2-1 to form Grind Vehicle 2.

Grind Vehicle 2-1: The amine-acid salt quaternizing agent was prepared using the materials listed in Table 9-1 according to the following procedure:

Table 9-1

| # | Material | Parts (g) |
|---|---|---|
| 1 | Dimethyl ethanolamine | 445 |
| 2 | PAPI 290¹ | 660 |
| 3 | Butyl Carbitol Formal² | 22.1 |
| 4 | 88% lactic acid aqueous | 512 |
| 5 | Deionized water | 2136.11 |

¹ Polymeric diisocyanate commercially available from Dow Chemical Co.
² Available as Mazon 1651 from BASF Corporation.

To a suitably equipped 5-liter flask material 1 was charged. Material 2 was then charged under mild agitation over a 1.5-hour period, followed by a rinse of Material 3. During this addition, the reaction mixture was allowed to exotherm to a temperature of about 89° C. and held at that temperature for about 1 hour until complete reaction of the isocyanate as determined by infrared spectroscopy. At that time, Material 4 was added over a 25-minute period, followed Material 5. The reaction temperature was held at about 80° C. for about 6 hours until a stalled acid value of 70.6 was obtained, measured using a Metrohm 799 MPT Titrino automatic titrator utilizing a 0.1 M potassium hydroxide solution in methanol.

Grind Vehicle 2-2: The quaternary ammonium salt group-containing polymer was prepared using the materials listed in Table 9-2 according to the following procedure:

Table 9-2

| # | Material | Parts(g) |
|---|---|---|
| 1 | Bisphenol A Diglycidyl ether¹ | 528.8 |
| 2 | Bisphenol A | 224.9 |
| 3 | Butyl Carbitol Formal² | 83.7 |
| 4 | Ethyltriphenylphosphonium iodide | 0.5 |
| 5 | Butyl Carbitol Formal² | 164.9 |
| 6 | amine-acid salt quaternizing agent 2-1 | 418.4 |
| 7 | Deionized water | 1428.1 |
| 8 | Butyl Carbitol Formal² | 334.7 |

¹ Diglycidyl ether of Bisphenol A commercially available from Resolution Chemical Co as EPON 828.
² Available as Mazon 1651 from BASF Corporation.

Material 1 was charged to a suitably equipped 5-liter flask, under mild agitation. Material 2 was then added followed by Material 3 and Material 4. The reaction mixture was heated to about 140° C., allowed to exotherm to about 180° C., then cooled to about 160° C. and held at that temperature for about 1 hour. At that time the polymeric product had an epoxy equivalent weight of 982.9, as measured using a Metrohm 799 MPT Titrino automatic titrator utilizing a 1 M perchloric acid solution in acetic acid. The reaction mixture was then cooled to a temperature of about 130° C. at which time Material 5 was added and the temperature lowered to about 95°-100° C., followed by the addition of Material 6, the amine-acid quaternizing agent of 2-1 over a period of 15 minutes, and subsequently followed by the addition of about 1428.1 parts by weight of deionized water. The reaction temperature was held at about 80° C. for approximately 6 hours until the acid number of the reaction product fell below 1.0, as measured using a Metrohm 799 MPT Titrino automatic titrator utilizing a 0.1 M potassium hydroxide solution in methanol. The resultant quaternary ammonium salt group-containing pigment grinding resin was further reduced to reduce solids content with about 334.7 parts by weight of the solvent of Butyl Carbitol Formal.

### Example 10 Preparation of the Pigment Paste 1

The pigment dispersion was prepared by sequentially adding the ingredients listed below under high shear agitation. When the ingredients were thoroughly blended, the pigment dispersion was transferred to a vertical sand mill and ground to a Hegman value of > 7.5 as measured using a Hegman gauge.

Table 10

| # | Material | PARTS BY WEIGHT |
|---|---|---|
| 1 | Grind Vehicle 1 | 734.02 |
| 2 | n-butoxypropanol | 28.23 |
| 3 | Silica Pigment¹ | 96.95 |
| 4 | DI Water | 57.57 |

¹Gasil IJ35 supplied by INEOS

### Example 11 Preparation of the Pigment Paste 2

The pigment dispersion was prepared by sequentially adding the ingredients listed below under high shear agitation. When the ingredients were thoroughly blended, the pigment dispersion was transferred to a vertical sand mill and ground to a Hegman value of > 7.5.

Table 11

| # | Material | PARTS BY WEIGHT |
|---|---|---|
| 1 | Grind Vehicle 1 | 308.76 |
| 2 | Grind Vehicle 2 | 121.90 |
| 3 | Dioctyl Tin Oxide | 324.04 |
| 4 | DI Water | 168.52 |
| 5 | Butyl Carbitol Formal | 11.23 |

### Example 12 Preparation of the Pigment Paste 3

The catalyst free pigment dispersion was prepared by sequentially adding ingredients 1-7 listed below under high shear agitation. When the ingredients were thoroughly blended, the pigment dispersion was transferred to a vertical sand mill and ground to a Hegman value of > 7.5. Charge 8 was then mixed into the paste with a Cowles blade for 1 hour.

Table 12

| # | Material | PARTS BY WEIGHT |
|---|---|---|
| 1 | Grind Vehicle 1 | 1928.77 |
| 2 | Grind Vehicle 2 | 1411.99 |
| 3 | N-butoxypropanol | 115.99 |
| 4 | Printex 200¹ | 93.00 |
| 5 | ASP 200² | 115.41 |
| 6 | Titanium Dioxide³ | 3256.59 |
| 7 | Deionized water | 70.98 |
| 8 | Pigment paste 1 | 3339.60 |

¹ Carbon Black pigment suppled from Orion Engineered Carbon
² Kaolin Clay available from BASF corporation
³ Pigment grade from The Chemours Company

### Example 13: Preparation of a Bismuth Catalyst Solution

An aqueous bismuth methane sulfonate catalyst solution was prepared using the ingredients from Table 13 in the following manner: Component 1 was added to an Erlenmeyer flask with stirring, followed by the sequential introduction of Components 2 and 3. The content of the flask was stirred for 3 hours at room temperature, and the resulting catalyst solution was then filtered through a Buchner funnel to remove any undissolved residue.

Table 13

| # | Material | Parts (g) |
|---|---|---|
| 1 | Deionized water | 3645.05 |
| 2 | Methanesulfonic acid¹ | 220.07 |
| 3 | Bismuth(III) oxide² | 172.16 |

¹70% solution in deionized water.
² 5N Frit grade.

Example 14: Preparation of Comparative Electrodepositable Coating Compositions A and B

Table 14

| | | Paint (g) | |
|---|---|---|---|
| No. | Material | Comp. A | Comp. B |
| 1 | Cationic Resin I | 1119.75 | - |
| | Comparative Resin II | - | 1134.71 |
| 2 | Cationic Resin Va | 155.89 | 155.89 |
| 3 | FEX-1651 | 16.67 | 16.67 |
| 4 | Cationic Resin VIIa | 50.72 | 50.72 |
| 5 | DI Water | 81.6 | 66.65 |
| 6 | Pigment Paste 3 | 191.8 | 191.8 |
| 7 | Pigment Paste 2 | 17.7 | 17.7 |
| 8 | DI Water | 1365.8 | 1365.8 |

For each paint composition, Charges 1- 5 were added sequentially into a plastic container at room temperature under agitation with 10 minutes of stirring after each addition. The mixture was stirred for at least 30 minutes at room temperature. Charges 6 and 7 were then added and the paint was allowed to stir until uniform, a minimum of 30 minutes. Charge 8 was added, and the paint was allowed to stir for a minimum of 30 minutes until uniform. The resulting cationic electrodepositable paint compositions had a solids content of 20.5%, determined as by described previously, and a pigment to binder ratio of 0.12/1.0 by weight.

After 20% ultrafiltration (and reconstitution with deionized water), coated panels were prepared from baths separately containing the cationic electrodepositable paint compositions and were evaluated for solvent resistance by double acetone rubs. The results are reported below.

Example 15: Preparation of Experimental Electrodepositable Coating Composition C and Comparative Electrodepositable Coating Composition D

Table 15

| | | Paint | |
|---|---|---|---|
| No. | Material | C | Comp. D |
| 1 | Cationic Resin I | 1119.75 | - |
| | Comparative Resin II | - | 1134.71 |
| 2 | Cationic Resin Va | 155.89 | 155.89 |
| 3 | FEX-1651 | 16.67 | 16.67 |
| 4 | Cationic Resin VIIa | 50.72 | 50.72 |
| 5 | Example 13 | 204.13 | 204.13 |
| 6 | Pigment Paste 3 | 191.8 | 191.8 |
| 7 | DI Water | 1261.0 | 1261.0 |

For each paint composition, Charges 1- 5 were added sequentially into a plastic container at room temperature under agitation with 10 minutes of stirring after each addition. The mixture was stirred for at least 30 minutes at room temperature. Charge 6 was then added, and the paint was allowed to stir until uniform, a minimum of 30 minutes. Charge 7 was added, and the paint was allowed to stir for a minimum of 30 minutes until uniform. The resulting cationic electrodepositable paint compositions had a solids content of 20.5%, determined as by described previously, and a pigment to binder ratio of 0.12/1.0 by weight.

After 20% ultrafiltration (and reconstitution with deionized water), coated panels were prepared from baths separately containing the cationic electrodepositable paint compositions and were evaluated for solvent resistance by double acetone rubs. The results are reported below.

Example 16: Preparation of Electrodepositable Coating Compositions E-J

Table 16

| | | Paint | | | | | |
|---|---|---|---|---|---|---|---|
| No. | Material | E | F | G | H | Comp. I | Comp. J |
| 1 | Resin IA | 768.13 | - | - | - | - | - |
| | Resin IB | - | 808.61 | - | - | - | - |
| | Resin IC | - | - | 1013.14 | - | - | - |
| | Resin ID | - | - | - | 1010.61 | - | - |
| | Resin IE | - | - | - | - | 960.20 | - |
| | Resin IIA | - | - | - | - | - | 1033.35 |
| 2 | Cationic Resin Vb | 87.76 | 87.76 | 111.69 | 111.69 | 111.69 | 111.69 |
| 3 | FEX-1651 | 12.22 | 12.22 | 15.56 | 15.56 | 15.56 | 15.56 |
| 4 | Example 13 | 149.69 | 149.69 | 190.52 | 190.52 | 190.52 | 190.52 |
| 5 | Cationic Resin VIIb | 38.03 | 38.03 | 48.41 | 48.41 | 48.41 | 48.41 |
| 6 | DI Water | 78.74 | 38.27 | 64.69 | 67.23 | 117.64 | 44.49 |
| 7 | Pigment Paste 3 | 140.7 | 140.7 | 179.0 | 179.0 | 179.0 | 179.0 |
| 8 | DI Water | 924.7 | 924.7 | 1176.9 | 1176.9 | 1176.9 | 1176.9 |

For each paint composition, Charges 1- 5 were added sequentially into a plastic container at room temperature under agitation with 10 minutes of stirring after each addition. The mixture was stirred for at least 30 minutes at room temperature. Charges 6 and 7 were then added and the paint was allowed to stir until uniform, a minimum of 30 minutes. Charge 8 was added and the paint was allowed to stir for a minimum of 30 minutes until uniform. The resulting cationic electrodepositable paint compositions had a solids contend of 20.5%, determined as by described previously, and a pigment to binder ratio of 0.12/1.0 by weight.

Coated panels were prepared from baths separately containing the cationic electrodepositable paint compositions and were evaluated for solvent resistance by double acetone rubs. The results are reported below.

Example 17: Preparation of Electrodepositable Coating Compositions K-M

Table 17

| | | Paint | | |
|---|---|---|---|---|
| No. | Material | K | L | Comp. M |
| 1 | Resin IA | - | - | 979.40 |
| | Resin ID | 1010.61 | 1010.61 | - |
| | Resin IE | - | - | - |
| 2 | Cationic Resin Vb | 111.69 | 111.69 | 111.69 |
| 3 | FEX-1651 | 15.56 | 15.56 | 15.56 |
| 4 | Example 13 | 285.78 | 381.04 | - |
| 5 | Cationic Resin VIIb | 48.41 | 48.41 | 48.41 |
| 6 | DI Water | 23.82 | 28.29 | 175.21 |
| 7 | Pigment Paste 3 | 180.8 | 180.8 | 163.9 |
| 8 | Pigment Paste 2 | - | - | 16.5 |
| 9 | DI Water | 1123.4 | 1023.6 | 1289.1 |

For each paint composition, Charges 1-5 were added sequentially into a plastic container at room temperature under agitation with 10 minutes of stirring after each addition. The mixture was stirred for at least 30 minutes at room temperature. Charges 6 through 8 were then added and the paint was allowed to stir until uniform, a minimum of 30 minutes. Charge 9 was added and the paint was allowed to stir for a minimum of 30 minutes until uniform. The resulting cationic electrodepositable paint compositions had a solids contend of 20.5%, determined as by described previously, and a pigment to binder ratio of 0.12/1.0 by weight.

Coated panels were prepared from baths separately containing the cationic electrodepositable paint compositions and were evaluated for solvent resistance by double acetone rubs. The results are reported below.

Example 18: Preparation of Electrodepositable Coating Compositions N-Q

Table 18

| | | Paint | | | |
|---|---|---|---|---|---|
| No. | Material | N | O | Comp. P | Q |
| 1 | Resin IF | 1018.24 | - | - | - |
| | Resin IG | - | 1059.06 | - | - |
| | Resin IIB | - | - | 1020.82 | - |
| | Resin IA | - | - | - | 978.80 |
| 2 | Cationic Resin Vb | 111.69 | 111.69 | 111.69 | 111.69 |
| 3 | FEX-1651 | 15.56 | 15.56 | 15.56 | 15.56 |
| 4 | Example 13 | 190.52 | 190.52 | 190.52 | 95.26 |
| 5 | Cationic Resin VIIb | 48.41 | 48.41 | 48.41 | 48.41 |
| 6 | DI Water | 23.46 | 18.77 | 57.02 | 246.16 |
| 7 | Pigment Paste 3 | 180.4 | 179.0 | 179.0 | 180.8 |
| 8 | DI Water | 1211.4 | 1176.9 | 1176.9 | 1123.4 |

For each paint composition, Charges 1- 5 were added sequentially into a plastic container at room temperature under agitation with 10 minutes of stirring after each addition. The mixture was stirred for at least 30 minutes at room temperature. Charges 6 and 7 were then added and the paint was allowed to stir until uniform, a minimum of 30 minutes. Charge 8 was added and the paint was allowed to stir for a minimum of 30 minutes until uniform. The resulting cationic electrodepositable paint compositions had a solids contend of 20.5%, determined as by described previously, and a pigment to binder ratio of 0.12/1.0 by weight.

Coated panels were prepared from baths separately containing the cationic electrodepositable paint compositions and were evaluated for solvent resistance by double acetone rubs. The results are reported below.

### Evaluation of Cationic Electrodepositable Coating Compositions

The composition of each of paints above was coated over 4" X 6" X 0.032" C700 No Chemseal immersion DI water rinsed steel panel, (supplied by the ACT Test Panels LLC.), for cure by solvent rub testing. Coating conditions for both substrates were 190 volts for 3 minutes at a bath temperature of 30-34° C. Coated substrates were rinsed with deionized water and air dried for a period of at least 30 minutes.

### Cure Evaluation of Electrodeposited Coatings

The electrodepositable coatings coated onto 4" X 6" 0.032" C700 No Chemseal immersion DI water rinsed steel panel by the methods set forth above were baked at 140° C., 150° C., 155° C., and 175° C. with a fixed bake time of 25 minutes using an electric oven (Despatch Industries, model LFD- series). Each of the panels had a dry film thickness between 0.7 to 0.9 mils (17 to 23 microns). The baked electrodeposited coatings were double rubbed with a cotton glove supplied by Uline Company placed over top of nitrile glove soaked with excess amount of acetone for testing. The rubs are counted as a double rub (one rub forward and rub backward constitutes a double rub). The cure temperature (TCURE) was determined for the bake temperature that leads to an electrodeposited coating with no physical damage down to metal of the coating after 100 double rubs with acetone. This test method is referred to herein as the DOUBLE RUB TEST (DBA) METHOD.

The electrodepositable coatings were coated on 200-gauge aluminum foils by the methods set forth above were used for non-isothermal thermogravimetric analysis ("TGA") using a thermogravimetric analyzer (TGA Q500, TA Instruments, Inc.). The TGA data was collected at a ramping rate of 5° C./min in the temperature range from 20° C. to 250° C. It is generally understood that the unblocking reaction of blocked isocyanates in crosslinkers has a direct impact on the crosslinking reaction of blocked isocyanates and polymer systems containing hydroxyl or amine groups. The theory behind the thermogravimetric analysis is that the weight loss is the result of the blocking agent deblocking from the isocyanato group on the polyisocyanate and volatilizing out of the coating layer leading to weight loss from the coating layer. The TGA data measures the unblocking reaction profile from the 1ₛₜ derivative weight loss profile over the temperature range to determine the crosslinking reaction temperature. This test method is referred to herein as the TGA TEST METHOD. The results are summarized below as T_{CURE} _{TGA}.

Table 19

| | Bake Condition - 25 min in electric oven | | | | |
|---|---|---|---|---|---|
| Paint | 175° C. | 155° C. | 150° C. | 140° C. | T_{Cure} _{DBA} |
| Comp. A | 100 | 100 | 65 | 8 | 155 |
| Comp. B | 100 | 24 | 3 | 1 | 175 |
| C | 100 | 100 | 100 | 100 | 140 |
| Comp. D | 100 | 100 | 100 | 5 | 150 |

The results in the table above show the surprising result that the combination of bismuth catalyst with the blocked polyisocyanate having blocking groups comprising propylene glycol has the lowest cure temperature of all paints tested.

Table 20

| Example | % 1,2-diol blocking agent | 175° C. | 155° C. | 150° C. | 140° C. | T_{CURE} _{DBA} | T_{CURE} _{TGA} |
|---|---|---|---|---|---|---|---|
| E | 100% | 100 | 100 | 100 | 100 | 140 | 141.85 |
| F | 80% | 100 | 100 | 100 | 100 | 140 | 154.23 |
| G | 60% | 100 | 100 | 100 | 100 | 140 | 151.1 |
| H | 40% | 100 | 100 | 100 | 100 | 140 | 167.43 |
| Comp. I | 20% | 100 | 100 | 100 | 52 | 150 | 169.07 |
| Comp. J | 0% | 100 | 100 | 64 | 9 | 155 | 171.75 |

The results above show that a sufficient amount of propylene glycol is needed to achieve lower temperature cure than a non-diol blocking group with bismuth catalyst.

Table 21

| Example | % 1,2-diol blocking agent | Bi Level | 175° C. | 155° C. | 150° C. | 140° C. | T_{CURE} DBA | T_{CURE} TGA |
|---|---|---|---|---|---|---|---|---|
| H | 40% | 1% | 100 | 100 | 100 | 100 | 140 | 167.43 |
| K | | 1.50% | 100 | 100 | 100 | 95 | 150 | 169.46 |
| L | | 2.00% | 100 | 100 | 100 | 100 | 140 | 168.95 |
| E | 100% | 1.00% | 100 | 100 | 100 | 100 | 140 | 141.85 |
| Q | | 0.50% | 100 | 100 | 100 | 100 | 140 | 146.84 |

The results above show lower cure temperatures cannot be reached with an insufficient level of propylene glycol in the cross linker even with higher catalyst levels.

Table 22

| Example | Blocking Agent | 175° C. | 155° C. | 150° C. | 140° C. | T_{CURE} _{DBA} | T_{CURE} _{TGA} |
|---|---|---|---|---|---|---|---|
| E | 1,2-propane diol | 100 | 100 | 100 | 100 | 140 | 141.85 |
| N | 1,2-butane diol | 100 | 100 | 100 | 100 | 140 | 153.9 |
| O | 1,2-hexane diol | 100 | 100 | 100 | 100 | 140 | 148.97 |
| Comp. P | 1,3-butane diol | 100 | 100 | 82 | 36 | 155 | 160.13 |
| Comp. J | Diethylene glycol monobutyl ether | 100 | 100 | 64 | 9 | 155 | 172.84 |

The results above show a 1,2-diol structure is necessary for lower cure temperature with bismuth catalyst.

Table 23

| Example | Catalyst | 175° C. | 155° C. | 150° C. | 140° C. | T_{CURE} _{DBA} | T_{CURE} _{TGA} |
|---|---|---|---|---|---|---|---|
| E | Bismuth | 100 | 100 | 100 | 100 | 140 | 141.85 |
| Comp M | Tin | 100 | 100 | 100 | 29 | 150 | 169.44 |

The results above show the catalyst specificity for bismuth compared to tin for the cure temperature.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. An electrodepositable coating composition comprising:
an ionic salt group-containing film-forming polymer comprising active hydrogen functional groups;
a blocked polyisocyanate curing agent comprising blocking groups, wherein at least 30% of the blocking groups comprise a 1,2-polyol as a blocking agent, based upon the total number of blocking groups; and
a bismuth catalyst.

2. The electrodepositable coating composition of claim 1, wherein the blocked polyisocyanate curing agent comprises the structure: 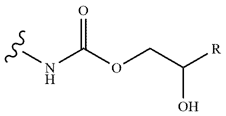
wherein R is hydrogen or a substituted or unsubstituted alkyl group comprising 1 to 8 carbon atoms.

3. The electrodepositable coating composition of claim 1, wherein the 1,2-polyol comprises 30% to 95% of the blocking groups of the blocked polyisocyanate curing agent, based upon the total number of blocking groups.

4. The electrodepositable coating composition of claim 1, wherein the 1,2-polyol comprises a 1,2-alkane diol.

5. The electrodepositable coating composition of claim 4, wherein the 1,2-alkane diol comprises ethylene glycol, propylene glycol, 1,2-butane diol, 1,2-pentane diol, 1,2-hexane diol, 1,2-heptanediol, 1,2-octanediol, or a combination thereof.

6. The electrodepositable coating composition of claim 1, wherein the 1,2-polyol comprises propylene glycol.

7. The electrodepositable coating composition of claim 1, wherein the blocked polyisocyanate curing agent further comprises a coblocking agent.

8-10. (canceled)

11. The electrodepositable coating composition of claim 1, wherein the bismuth catalyst comprises a bismuth oxide, a bismuth salt, or a combination thereof.

12. The electrodepositable coating composition of claim 1, wherein the bismuth catalyst comprises a bismuth carboxylate, a bismuth sulfamate, a bismuth sulphonate, a bismuth lactate, a bismuth subnitrate, or a combination thereof.

13. The electrodepositable coating composition of claim 1, wherein the bismuth catalyst comprises a soluble bismuth catalyst or an insoluble bismuth catalyst.

14. The electrodepositable coating composition of claim 1, wherein the bismuth catalyst comprises bismuth methane sulphonate.

15. The electrodepositable coating composition of claim 1, wherein the ionic salt group-containing film-forming polymer comprises a cationic salt group-containing film-forming polymer.

16. The electrodepositable coating composition of claim 1, wherein the ionic salt group-containing film-forming polymer comprises an anionic salt group-containing film-forming polymer.

17. (canceled)

18. The electrodepositable coating composition of claim 1, wherein the blocked polyisocyanate curing agent is present in the electrodepositable coating composition in an amount of 10% to 60% by weight, based on the total weight of the resin solids of the electrodepositable coating composition.

19. The electrodepositable coating composition of claim 1, wherein the ionic salt group-containing film-forming polymer is present in the electrodepositable coating composition in an amount of 40% to 90% by weight, based on the total weight of the resin solids of the electrodepositable coating composition.

20. The electrodepositable coating composition of claim 1, wherein the electrodepositable coating composition further comprises a co-catalyst.

21-22. (canceled)

23. The electrodepositable coating composition of claim 1, wherein the electrodepositable coating composition is substantially free of bismuth subnitrate, bismuth oxide, bismuth silicate, bismuth titanate, bismuth sulfamate, and/or bismuth lactate.

24. The electrodepositable coating composition of claim 1, wherein the bismuth catalyst is provided in an amount of at least 1% by weight bismuth metal, based on the total resin solids weight of the composition.

25. The electrodepositable coating composition of claim 1, wherein the bismuth catalyst is provided in an amount of at least 0.5% by weight bismuth metal, based on the total resin solids weight of the composition, and the 1,2-polyol comprises 100% of the blocking groups of the blocked polyisocyanate curing agent, based upon the total number of blocking groups.

26. The electrodepositable coating composition of claim 1, wherein the bismuth catalyst is provided in an amount of at least 0.5% by weight bismuth metal, based on the total resin solids weight of the composition, and the 1,2-polyol comprises a percentage of the blocking groups of the blocked polyisocyanate curing agent, the percentage being greater than or equal to [(-1.2× + 1.6)*100]% or 30%, whichever is higher, wherein x is the weight percent of bismuth metal, and the percentage of blocking groups is based upon the total number of blocking groups.

27. The electrodepositable coating composition of claim 1, wherein the blocking groups are free of blocking agent comprising a polyester diol formed from the reaction of ethylene glycol, propylene glycol, or 1,4-butanediol with oxalic acid, succinic acid, adipic acid, suberic acid, or sebacic acid.

28. The electrodepositable coating composition of claim 1, wherein the electrodepositable coating composition further comprises a plasticizer.

29-31. (canceled)

32. The electrodepositable coating composition of claim 1, wherein the bismuth catalyst comprises a soluble bismuth catalyst, and the electrodepositable coating composition comprises solubilized bismuth metal in an amount of at least 0.04% by weight, based on the total weight of the electrodepositable coating composition.

33. The electrodepositable coating composition of claim 1, wherein the bismuth catalyst comprises a soluble bismuth catalyst, and the electrodepositable coating composition comprises solubilized bismuth metal in an amount of at least 0.22% by weight, based on the total resin solids weight of the electrodepositable coating composition.

34. A method of coating a substrate comprising electrophoretically applying a coating deposited from an electrodepositable coating composition of claim 1 to at least a portion of the substrate.

35. The method of claim 34, wherein the method further comprises heating the coated substrate to effectuate cure of the coating, and
the coating has a T_{Cure} of no more than 140° C., as measured by the DOUBLE RUB TEST METHOD, or
the coating has a T_{Cure} of less than 170° C., as measured by the TGA TEST METHOD, or
the coating has a T_{Cure} at least 10° C. less than the T_{cure} of a coating deposited from a comparative electrodepositable coating composition.

36-38. (canceled)

39. An at least partially cured coating formed by at least partially curing a coating deposited from an electrodepositable coating composition of claim 1.

40. A substrate coated with a coating deposited from the electrodepositable coating composition of claim 1 in an at least partially cured state.

41-42. (canceled)
